(19) United States
(12) Patent Application Publication
(10) Pub. No.: US 2015/0082894 A1
(43) Pub. Date: Mar. 26, 2015

(54) PRESSURE SENSOR AND PRESSURE SENSOR MANUFACTURING METHOD

(71) Applicant: KABUSHIKI KAISHA TOSHIBA, Tokyo (JP)

(72) Inventors: Kazuaki OKAMOTO, Fuchu Tokyo (JP); Hideaki FUKUZAWA, Kawasaki Kanagawa (JP); Yoshihiko FUJI, Kawasaki Kanagawa (JP); Michiko HARA, Yokohama Kanagawa (JP); Yoshihiro HIGASHI, Komatsu Ishikawa (JP)

(21) Appl. No.: 14/464,829

(22) Filed: Aug. 21, 2014

(30) Foreign Application Priority Data
Sep. 24, 2013 (JP) 2013-197553

(51) Int. Cl. G01L 9/00

(52) U.S. Cl. CPC G01L 9/0042
USPC 73/723; 29/832

(57) ABSTRACT

According to one embodiment, a pressure sensor includes: a support unit; a substrate; and a plurality of sensing elements. The substrate is supported by the support unit and deformable. The plurality of sensing elements are provided on a part of the substrate. The sensing element includes a first magnetic layer, a second magnetic layer, and an intermediate layer. Magnetization of the first magnetic layer changes according to deformation of the substrate. Magnetization of the second magnetic layer is fixed. The intermediate layer is provided between the first magnetic layer and the second magnetic layer. A direction of the magnetization of the second magnetic layer of a first sensing element among the plurality of sensing elements is different from a direction of the magnetization of the second magnetic layer of a second sensing element among the plurality of sensing elements.

### CROSS-REFERENCE TO RELATED APPLICATIONS

This application is based upon and claims the benefit of priority from Japanese Patent Application No. 2013-197553, filed on Sep. 24, 2013; the entire contents of which are incorporated herein by reference.

### FIELD

Embodiments described herein relate generally to a pressure sensor and a pressure sensor manufacturing method.

### BACKGROUND

In a capacitance change type pressure sensor, an overall diaphragm becomes a part of an electrode. Thus, the sensitivity of the pressure sensor is proportional to the area of a diaphragm film. On the other hand, in the case of a resistance change type pressure sensor, by increasing the number of sensing elements on the diaphragm film without change of the area of the diaphragm film, it is possible to increase the sensitivity of the pressure sensor and thus, it is desirable to increase the sensitivity of the pressure sensor.

### BRIEF DESCRIPTION OF THE DRAWINGS

FIG. 1 is a schematic perspective view illustrating a pressure sensor according to a first embodiment;

FIGS. 2A to 2D are schematic plan views illustrating the film part of the pressure sensor according to the first embodiment;

FIG. 3 is a schematic perspective view illustrating a sensing element of the embodiment;

FIGS. 4A and 4B are schematic perspective views illustrating another sensing element of the embodiment;

FIGS. 5A to 5D are schematic perspective views illustrating the sensing element used for the pressure sensor according to the embodiment;

FIG. 6 is a schematic perspective view illustrating another sensing element used in the embodiment;

FIGS. 7A and 7B are schematic plan views illustrating a case where the sensing element has shape isotropy;

FIGS. 8A and 8B are schematic plan views illustrating a case where the sensing element has shape anisotropy;

FIGS. 9A and 9B are schematic plan views illustrating a case where the sensing element has shape isotropy;

FIGS. 10A and 10B are schematic diagrams illustrating a case where the sensing element has shape anisotropy;

FIGS. 11A to 11C are schematic diagrams illustrating an operation of the pressure sensor according to the embodiment;

FIGS. 12A to 12C are schematic plan views illustrating change in magnetization with respect to stress;

FIGS. 13A to 13C are schematic plan views illustrating change in magnetization with respect to stress;

FIGS. 14A to 14C are schematic plan views illustrating change in magnetization with respect to stress;

FIG. 15 is a flowchart illustrating a method for manufacturing a pressure sensor according to a second embodiment;

FIGS. 16A to 16E are schematic process diagrams illustrating the method for manufacturing the pressure sensor;

FIGS. 17A to 17D are schematic process diagrams illustrating the method for manufacturing the sensing element illustrated in FIGS. 12A to 12C;

FIGS. 18A and 18B are schematic process diagrams illustrating the method for manufacturing the sensing element illustrated in FIGS. 13A to 13C;

FIGS. 19A to 19D are schematic process diagrams illustrating the method for manufacturing the sensing element illustrated in FIGS. 14A to 14C;

FIG. 20 is a graph illustrating the relationship between the stress applied to the sensing element illustrated in FIGS. 14A to 14C and the electrical resistance;

FIG. 21 is a schematic cross-sectional view illustrating a manufacturing apparatus of a pressure sensor according to a third embodiment;

FIG. 22 is a schematic cross-sectional view illustrating another manufacturing apparatus of the pressure sensor according to the third embodiment;

FIG. 23 is a schematic plan view illustrating a microphone according to a fourth embodiment;

FIG. 24 is a schematic cross-sectional view illustrating the acoustic microphone according to a fifth embodiment;

FIGS. 25A and 25B are schematic views illustrating the blood pressure sensor according to a sixth embodiment; and

FIG. 26 is a schematic plan view illustrating a touch panel according to a seventh embodiment.

### DETAILED DESCRIPTION

In general, according to one embodiment, pressure sensor includes: a support unit; a substrate; and a plurality of sensing elements. The substrate is supported by the support unit and deformable. The plurality of sensing elements are provided on a part of the substrate. The sensing element includes a first magnetic layer, a second magnetic layer, and an intermediate layer. Magnetization of the first magnetic layer changes according to deformation of the substrate. Magnetization of the second magnetic layer is fixed. The intermediate layer is provided between the first magnetic layer and the second magnetic layer. A direction of the magnetization of the second magnetic layer of a first sensing element among the plurality of sensing elements is different from a direction of the magnetization of the second magnetic layer of a second sensing element among the plurality of sensing elements.

Various embodiments will be described hereinafter with reference to the accompanying drawings.

The drawings are schematic or conceptual; and the proportion of a portion, or the like is not necessarily the same as an actual proportion. Further, the dimensions or the proportion may be illustrated differently between the drawings, even for identical portions.

In the drawings and the specification of the application, components similar to those described in regard to a preceding drawing are marked with like reference numerals, and a detailed description thereof is omitted as appropriate.

### First Embodiment

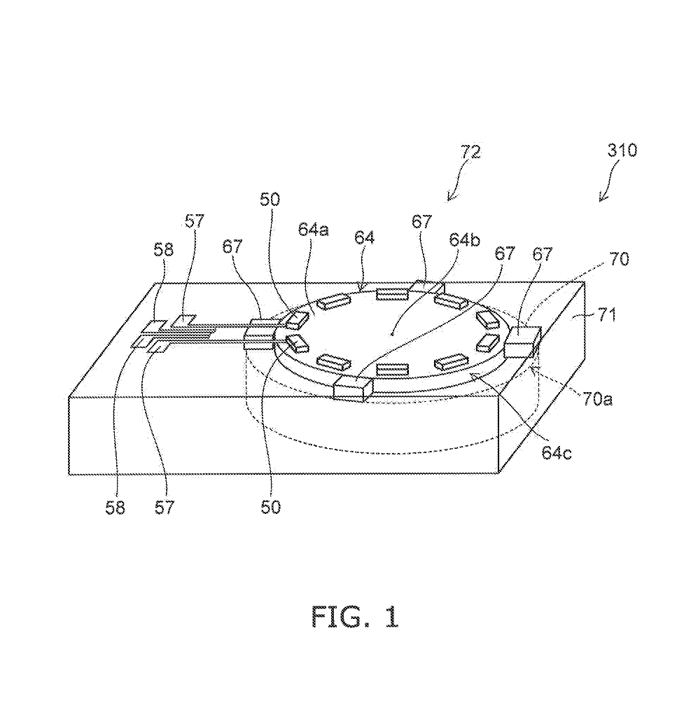

FIG. 1 is a schematic perspective view illustrating a pressure sensor according to a first embodiment.

In FIG. 1, for ease of description, insulating portions are not shown, and conductive portions are primarily shown. Further, for ease of description, only a part of plural sensing elements 50 is shown.

As illustrated in FIG. 1, a pressure sensor 310 includes a base unit (support unit) 71 and a sensor unit 72.

The sensor unit 72 is provided on the base unit 71. The sensor unit 72 includes a film part (substrate) 64, a fixing part 67, and the sensing elements 50.

The film part 64 is a deformable film. The film part 64 is flexible, that is, can be bent in a direction perpendicular to film surfaces 64a and 64b. The film part 64 is bent when external pressure is applied, and causes distortion in the sensing elements 50 provided thereon. The external pressure may be set as pressure due to sound waves, ultrasonic waves, pressing force or the like, for example. That is, the film part 64 is deformed if the external pressure is applied.

The film part 64 may be continuously formed on the outside from a portion that is bent by the external pressure. In the specification, a portion that has a predetermined film thickness thinner than that of a fixed end and that is bent by the external pressure is set as the film part 64.

The film part 64 may be formed using an insulating material such as silicon oxide or silicon nitride, for example. Further, the film part 64 may be formed using a semiconductor material such as silicon, or using a metal material other than the semiconductor material.

The thickness size of the film part 64 may be set to 200 nm or more and 3 μm or less, for example. In such a case, preferably, the thickness size may be set to 300 nm or more and 1.5 μm or less,

As illustrated in FIG. 1, when a plane shape of the film part 64 is circular, the diameter size of the film part 64 may be set to 1 μm or more and 600 μm or less, for example. In such a case, preferably, the diameter size may be set to 60 μm or more and 600 μm or less.

The fixing part 67 fixes the film part 64 to the base unit 71. The fixing part 67 has a thickness size thicker than that of the film part 64 so that the fixing part 67 is not easily bent even when the external pressure is applied.

The fixing part 67 may be provided at an equal interval on the peripheral edge of the film part 64 as illustrated in FIG. 1, or may be provided to surround the entire peripheral edge of the film part 64.

Under the film part 64, a hollow part 70 may be present. The hollow part 70 may be filled with gas such as air or inert gas, or may be filled with liquid.

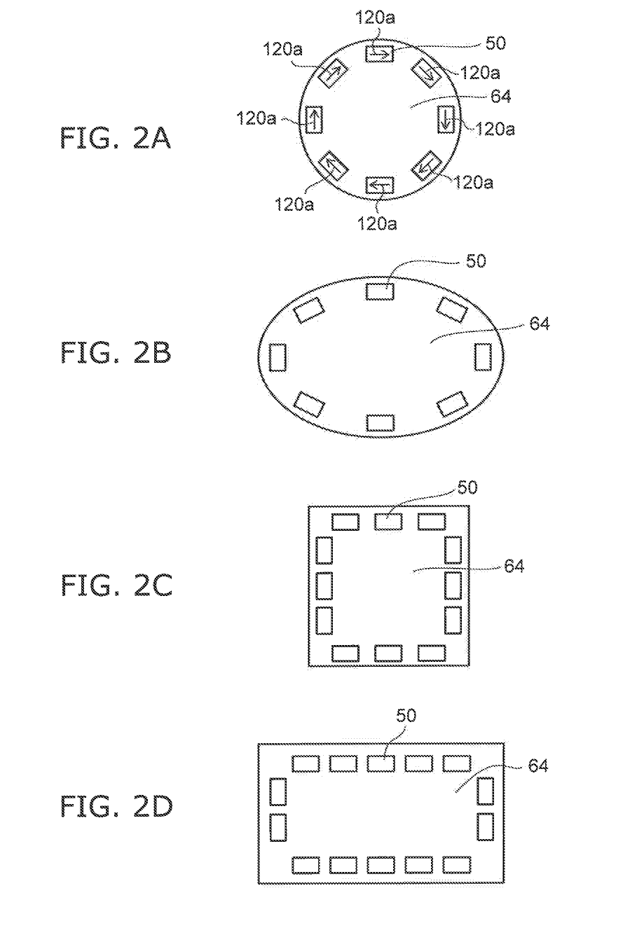

FIGS. 2A to 2D are schematic plan views illustrating the film part of the pressure sensor according to the first embodiment.

The film part 64 may have shape isotrophy, as illustrated in FIG. 2A or 2C, or may have shape anisotrophy, as illustrated in FIG. 2B or 2D.

An arrow illustrated in FIG. 2A represents an example of a magnetization 120a of a magnetization fixed layer. Here, the magnetization 120a of the magnetization fixed layer is not limited thereto.

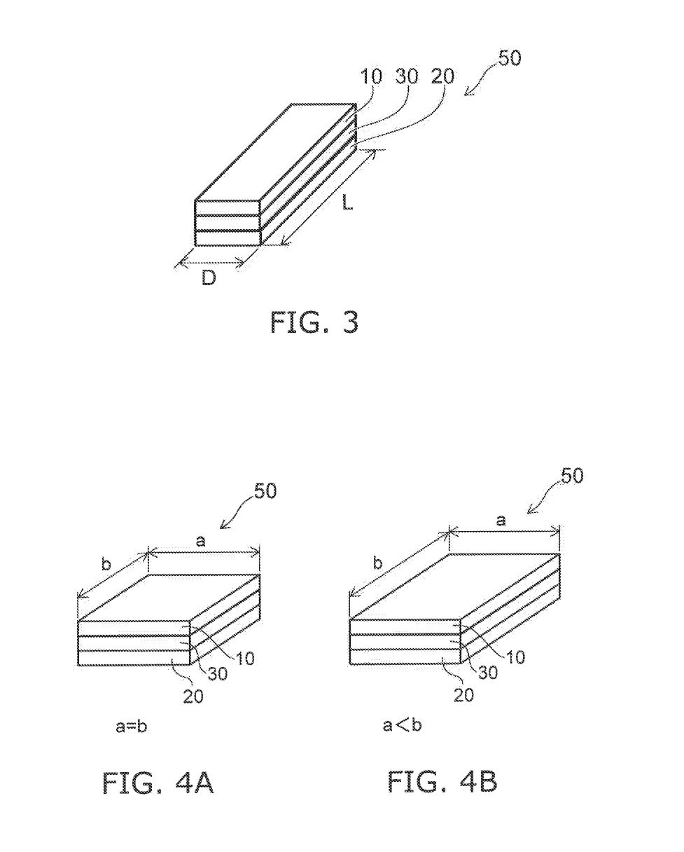

FIG. 3 is a schematic perspective view illustrating a sensing element of the embodiment.

FIGS. 4A and 4B are schematic perspective views illustrating another sensing element of the embodiment.

The sensing element 50 includes a magnetic layer 10, a magnetic layer 20, and an intermediate layer 30 provided between the magnetic layer 10 and the magnetic layer 20. The intermediate layer 30 is a non-magnetic layer. Each of the plural sensing elements 50 on the film part 64 has the above-mentioned configuration. The magnetic layer 10 may be a first magnetic layer in which the magnetization is freely changed, or may be a second magnetic layer in which the magnetization is fixed. Similarly, the magnetic layer 20 may be the second magnetic layer, or may be the first magnetic layer.

The magnetic layer 10 of the sensing element 50 is connected to a first interconnect 57 (see FIG. 1). The magnetic layer 20 of the sensing element 50 is connected to a second interconnect 58 (see FIG. 1). A current flows in a direction from the magnetic layer 10 to the magnetic layer 20 or in a direction from the magnetic layer 20 to the magnetic layer 10.

The first interconnect 57 and the second interconnect 58 extend outward from the film part 64 through an upper side of the fixing part 67 or an inner side of the fixing part 67.

The sensing element 50 has shape anisotropy as illustrated in FIG. 3 or 4B, and may have shape isotropy as illustrated in FIG. 4A. In the figures, a square is employed as an example of the shape of the element having isotropy, and a rectangle is employed as an example of the shape of the element having anisotropy. In the following description, as examples of the elements having isotropy and anisotropy, these shapes are employed.

The thickness size of the magnetic layer 10 and the magnetic layer 20 may be set 1 nm or more and 20 nm or less, for example. In such a case, it is favorable that the thickness size of the magnetic layer 10 and the magnetic layer 20 be set 2 nm or more and 6 nm or less.

Hereinafter, an example of the sensing element used for the pressure sensor according to the embodiment will be described.

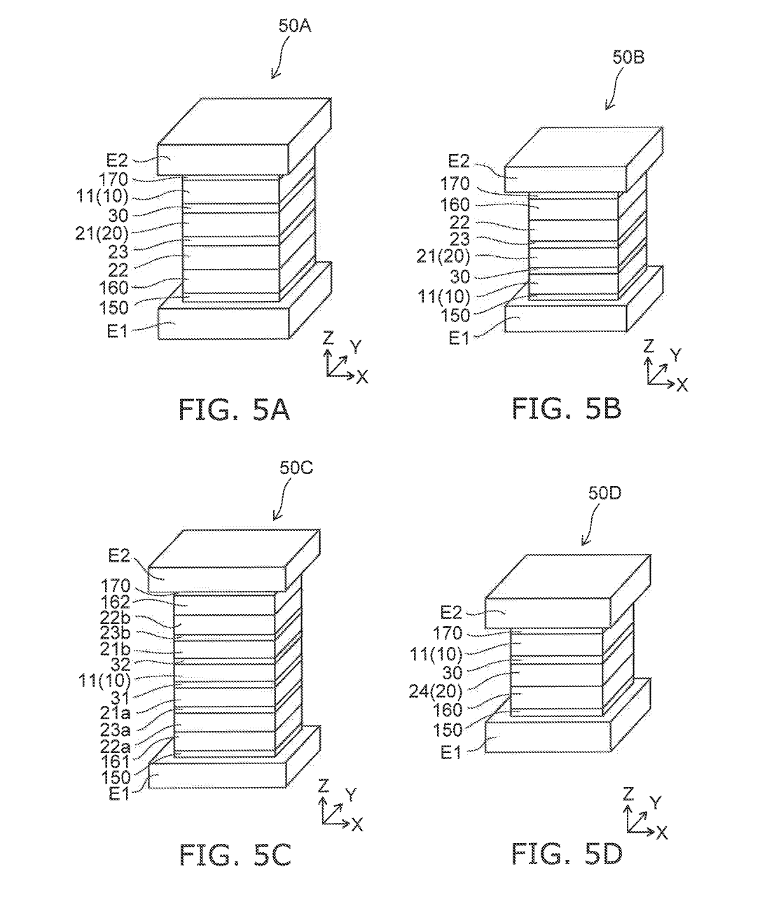

FIGS. 5A to 5D are schematic perspective views illustrating the sensing element used for the pressure sensor according to the embodiment.

Hereinafter, “material A/material B” represents a state in which a layer of material B is provided on a layer of material A.

FIG. 5A is a schematic perspective view illustrating the sensing element used in the embodiment.

As illustrated in FIG. 5A, a sensing element 50A used in the embodiment includes a lower electrode E1, a foundation layer 150, a pinning layer 160, a second magnetization fixed layer 22, a magnetic coupling layer 23, a first magnetization fixed layer 21, the intermediate layer 30, a magnetization free layer 11, a capping layer 170, and an upper electrode E2 arranged in order.

In the example, the magnetization free layer 11 corresponds to the first magnetic layer 10, and the first magnetization fixed layer 21 corresponds to the second magnetic layer 20. The sensing element 50A is a bottom spin-valve type element.

The foundation layer 150 includes, for example, Ta/Ru. The thickness (the length in the Z-axis direction) of the Ta layer is, for example, 3 nm. The thickness of the Ru layer is, for example, 2 nm.

The pinning layer 160 includes, for example, an IrMn layer having a thickness of 7 nm. The second magnetization fixed layer 22 includes, for example, a Co₇₅Fe₂₅ layer having a thickness of 2.5 nm. The magnetic coupling layer 23 includes, for example, an Ru layer having a thickness of 0.9 nm.

The first magnetization fixed layer 21 includes, for example, a Co₄₀Fe₄₀B₂₀ layer having a thickness of 3 nm. The intermediate layer 30 includes, for example, an MgO layer having a thickness of 1.6 nm. The magnetization free layer 11 includes, for example, Co₄₀Fe₄₀B₂₀ having a thickness of 4 nm.

The capping layer 170 includes, for example, Ta/Ru. The thickness of the Ta layer is, for example, 1 nm. The thickness of the Ru layer is, for example, 5 nm.

The lower electrode E1 and the upper electrode E2 include, for example, at least one selected from aluminum (Al), an aluminum copper alloy (Al—Cu), copper (Cu), silver (Ag) and gold (Au). A current can be caused to efficiently flow in the sensing element 50A by using such a material that has a relatively small electrical resistance as the lower electrode E1 and the upper electrode E2.

The lower electrode E1 may have a structure in which at least one layer selected from Al, Al—Cu, Cu, Ag and Au is provided between a capping layer (not shown) and a foundation layer (not shown) for the lower electrode E1. For example, the lower electrode E1 includes tantalum (Ta),/copper (Cu)/tantalum (Ta), or the like. For example, it is possible to improve adhesion between the film part 64 and the lower electrode E1 by using Ta as the foundation layer for the lower electrode E1. Titanium (Ti), titanium nitride (TN) or the like may be used as the foundation layer for the lower electrode E1.

It is possible to prevent oxidization of the copper (Cu) or the like under the capping layer for the lower electrode E1 by using Ta as the capping layer. Titanium (Ti), titanium nitride (TN) or the like may be used as the capping layer for the lower electrode E1.

The foundation layer 150 may include a stacked structure of a buffer layer (not shown) and a seed layer (not shown). For example, the buffer layer reduces the irregularity of the surfaces of the lower electrode E1 and the film part 64, and improves the crystallinity of the layers stacked on the buffer layer. For example, at least one selected from the group consisted of tantalum (Ta), titanium (Ti), vanadium (V), tungsten (W), zirconium (Zr), hafnium (Hf) and chrome (Cr) is used as the buffer layer. An alloy including at least one material selected from these materials may be used as the buffer layer.

It is favorable that the thickness of the buffer layer be 1 nm or more and 10 nm or less. It is more favorable that the thickness of the buffer layer be 1 nm or more and 5 nm or less. The buffering effect is lost when the thickness of the buffer layer is too thin. The thickness of the sensing element 50 becomes excessively thick when the thickness of the buffer layer is too thick. The seed layer may be formed on the buffer layer, and the seed layer may have a buffering effect. The buffer layer may be omitted. The buffer layer includes, for example, a Ta layer having a thickness of 3 nm.

The seed layer (not shown) controls the crystal orientation of the layers stacked on the seed layer. The seed layer controls the crystal grain size of the layers stacked on the seed layer. A metal or the like having a face-centered cubic (fcc) structure, a hexagonal close-packed (hcp) structure or a body-centered cubic (bcc) structure is used as the seed layer.

By using ruthenium (Ru) having an hcp structure, NiFe having an fcc structure, or Cu having an fcc structure as the seed layer, for example, the crystal orientation of the spin-valve film on the seed layer can have an fcc (111) orientation. The seed layer includes, for example, a Cu layer having a thickness of 2 nm or an Ru layer having a thickness of 2 nm. To improve the crystal orientation of the layers formed on the seed layer, it is favorable that the thickness of the seed layer be 1 nm or more and 5 nm or less. It is more favorable that the thickness of the seed layer be 1 nm and 3 nm or less. Thus, the function of the seed layer of improving the crystal orientation is sufficiently realized. On the other hand, for example, in a case where it is unnecessary to cause the layers formed on the seed layer to have a crystal orientation (for example, in a case where an amorphous magnetization free layer is formed), the seed layer may be omitted. For example, an Ru layer having a thickness of 2 nm is used as the seed layer.

The pinning layer 160 provides unidirectional anisotropy to a ferromagnetic layer formed on the pinning layer 160 to fix the magnetization. In the example illustrated in FIG. 5A, the pinning layer 160 provides unidirectional anisotropy to a ferromagnetic layer of the second magnetization fixed layer 22 formed on the pinning layer 160 to fix the magnetization. The pinning layer 160 includes, for example, an antiferromagnetic layer. The pinning layer 160 includes, for example, at least one selected from the group consisted of Ir—Mn, Pt—Mn, Pd—Pt—Mn and Ru—Rh—Mn. The thickness of the pinning layer 160 is set appropriately to provide unidirectional anisotropy of sufficient strength.

In order to perform the fixing of the magnetization of the ferromagnetic layer being in contact with the pinning layer 160, a heat treatment is performed while a magnetic field is applied. The magnetization of the ferromagnetic layer being in contact with the pinning layer 160 is fixed in a direction of the magnetic field applied in the heat treatment. An annealing temperature is set to be equal to or higher than a blocking temperature of an antiferromagnetic material used in the pinning layer 160, for example. Further, when an antiferromagnetic layer including Mn is used, Mn may be diffused to a layer other than the pinning layer to reduce an MR change ratio. Accordingly, it is favorable to set the temperature to be equal to or lower than a temperature at which the diffusion of Mn occurs. For example, it is favorable to set the temperature to 200° C. or more and 500° C. or less. It is more favorable to set the temperature to 250° C. or more and 400° C. or less.

When Pt—Mn or Pd—Pt—Mn is used as the pinning layer 160, it is favorable that the thickness of the pinning layer 160 be 8 nm or more and 20 nm or less. It is more favorable that the thickness of the pinning layer 160 be 10 nm or more and 15 nm or less. The pinning layer 160 that provides the directional anisotropy may be thinner in a case where IrMn is used as the pinning layer 160 than in a case where PtMn is used as the pinning layer 160. In such a case, it is favorable that the thickness of the pinning layer 160 be 4 nm or more and 18 nm or less. It is more favorable that the thickness of the pinning layer 160 be 5 nm or more and 15 nm or less. The pinning layer 160 includes, for example, an Ir₂₂Mn₇₈ layer having a thickness of 7 nm. In a case where the Ir₂₂Mn₇₆ layer is used, a heat treatment of 320°-1H may be performed while a magnetic field of 10 KOe is applied, as a heat treatment condition in the magnetic field. In a case where a Pt₅₀Mn₅₀ layer is used, a heat treatment of 320° C.-10H may be performed while a magnetic field of 10 KOe is applied, as a heat treatment condition in the magnetic field.

The second magnetization fixed layer 22 includes, for example, a CoₓFe₁₀₀₋ₓ alloy (x being 0 at. % or more and 100 at. % or less), an NiₓFe₁₀₀₋ₓ alloy (x being 0 at. % or more and 100 at. % or less), or a material in which a non-magnetic element is added to these alloys. For example, at least one selected from the group consisted of Co, Fe and Ni is used as the second magnetization fixed layer 22. An alloy including at least one material selected from these materials may be used as the second magnetization fixed layer 22.

It is favorable that the thickness of the second magnetization fixed layer 22 be, for example, 1.5 nm or more and 5 nm or less. Thus, for example, it is possible to increase the strength of the unidirectional anisotropic magnetic field due to the pinning layer 160, For example, it is possible to increase the strength of the antiferromagnetic coupling magnetic field between the second magnetization fixed layer 22 and the first magnetization fixed layer 21 through the magnetic coupling layer 23 formed on the second magnetization fixed layer 22. It is favorable that the magnetic film thickness of the second magnetization fixed layer 22 (the product of a saturation magnetization Bs and a thickness t (Bs·t)) be substantially equal to the magnetic film thickness of the first magnetization fixed layer 21.

In a thin film, the saturation magnetization of Co₄₀Fe₄₀B₂₀ is about 1.9 T (teslas). For example, in a case where a Co₄₀Fe₄₀B₂₀ layer having a thickness of 3 nm is used as the first magnetization fixed layer 21, the magnetic film thickness of the first magnetization fixed layer 21 is 1.9 T×3 nm which is 5.7 Tnm. On the other hand, the saturation magnetization of Co₇₅Fe₂₅ is about 2.1 T. The thickness of the second magnetization fixed layer 22 to obtain a magnetic film thickness that is equal to the above-mentioned magnetic film thickness is 5.7 Tnm/2.1 T, which is 2.7 nm. In such a case, it is favorable that the second magnetization fixed layer 22 include Co₇₅Fe₂₅ having a thickness of about 2.7 nm. For example, a Co₇₅Fe₂₅ layer having a thickness of 2.5 nm is used as the second magnetization fixed layer 22.

In the sensing element 50A, a synthetic pinned structure of the second magnetization fixed layer 22, the magnetic coupling layer 23, and the first magnetization fixed layer 21 is used. Instead, a single pinned structure made of one magnetization fixed layer may be used. In a case where the single pinned structure is used, for example, a Co₄₀Fe₄₀B₂₀ layer having a thickness of 3 nm is used as the magnetization fixed layer. The same material as the first magnetization fixed layer 21 to be described later may be used as the ferromagnetic layer used in the magnetization fixed layer of the single pinned structure.

The magnetic coupling layer 23 causes antiferromagnetic coupling to occur between the second magnetization fixed layer 22 and the first magnetization fixed layer 21. The magnetic coupling layer 23 forms a synthetic pinned structure. For example, Ru is used as the magnetic coupling layer 23. It is favorable that the thickness of the magnetic coupling layer 23 be 0.8 nm or more and 1 nm or less. A material other than Ru may be used as the magnetic coupling layer 23 as long as the material can cause sufficient antiferromagnetic coupling to occur between the second magnetization fixed layer 22 and the first magnetization fixed layer 21. The thickness of the magnetic coupling layer 23 may be set to be a thickness of 0.8 nm or more and 1 nm or less that corresponds to the second peak (2nd peak) of Ruderman-Kittel-Kasuya-Yosida (RKKY) coupling. Further, the thickness of the magnetic coupling layer 23 may be set to be a thickness of 0.3 nm or more and 0.6 nm or less that corresponds to the first peak (1st peak) of RKKY coupling. For example, Ru having a thickness of 0.9 nm is used as the magnetic coupling layer 23. Thus, highly reliable coupling is obtained more stably.

The magnetic layer that is used in the first magnetization fixed layer 21 (the second magnetic layer 20) contributes directly to the MR effect. For example, a Co—Fe—B alloy is used as the first magnetization fixed layer 21. Specifically, a (CoₓFe₁₀₀₋ₓ)_{100-y}B_{y} alloy (x being 0 at. % or more and 100 at. % or less and y being 0 at. % or more and 30 at. % or less) may be used as the first magnetization fixed layer 21. In a case where an amorphous alloy of (CoₓFe₁₀₀₋ₓ)_{100-y}B_{y} is used as the first magnetization fixed layer 21, for example, it is possible to suppress the fluctuation between the elements due to the crystal grains even in a case where the size of the sensing element 50A is small.

The layer (e.g., a tunneling insulating layer (not shown)) that is formed on the first magnetization fixed layer 21 (the second magnetic layer 20) may be planarized. By planarizing the tunneling insulating layer, it is possible to reduce the defect density of the tunneling insulating layer. Thus, a higher MR change ratio is obtained with a lower resistance per area. For example, in a case where MgO is used as a material of the tunneling insulating layer, it is possible to improve the (100) orientation of the MgO layer formed on the tunneling insulating layer by using an amorphous alloy of (CoₓFe₁₀₀₋ₓ)_{100-y}B_{y}. A higher MR change ratio is obtained by improving the (100) orientation of the MgO layer. The (CoₓFe₁₀₀₋ₓ)_{100-y}B_{y} alloy crystallizes the (100) plane of the MgO layer as a template in the annealing. Therefore, excellent crystal conformation between the MgO and (CoₓFe₁₀₀₋ₓ)_{100-y}B_{y} alloy is obtained. A higher MR change ratio is obtained by obtaining excellent crystal conformation.

Instead of the Co—Fe—B alloy, for example, an Fe—Co alloy may be used as the first magnetization fixed layer 21 (the second magnetic layer 20).

The MR change ratio increases as the thickness of the first magnetization fixed layer 21 (the second magnetic layer 20) increases. A thinner first magnetization fixed layer 21 is favorable to obtain a larger fixed magnetization field. A trade-off relationship in the thickness of the first magnetization fixed layer 21 exists between the MR change ratio and the fixed magnetization field. In a case where the Co—Fe—B alloy is used as the first magnetization fixed layer 21, it is favorable that the thickness of the first magnetization fixed layer 21 be 1.5 nm or more and 5 nm or less. It is more favorable that the thickness of the first magnetization fixed layer 21 be 2.0 nm or more and 4 nm or less.

Other than the materials described above, the first magnetization fixed layer 21 (the second magnetic layer 20) may include a Co₉₀Fe₁₀ alloy having an fcc structure, Co having an hcp structure, or a Co alloy having an hcp structure. At least one selected from the group consisted of Co, Fe, and Ni may be used as the first magnetization fixed layer 21. An alloy including at least one material selected from these materials may be used as the first magnetization fixed layer 21. For example, a higher MR change ratio is obtained by using an FeCo alloy material having a bcc structure, a Co alloy including a cobalt composition of 50 at. % or more, or a material having a Ni composition of 50 at. % or more as the first magnetization fixed layer 21. A Heusler magnetic alloy layer made of Co₂MnGe, Co₂FeGe, Co₂MnSi, Co₂FeSi, Co₂MnAl, Co₂FeAl, Co₂MnGa_{0.5}Ge_{0.5}, Co₂FeGa_{0.5}Ge_{0.5}, or the like may be used as the first magnetization fixed layer 21. For example, a Co₄₀Fe₄₀B₂₀ layer having a thickness of 3 nm may be used as the first magnetization fixed layer 21.

The intermediate layer 30 disconnects the magnetic coupling between the first magnetization fixed layer 21 and the magnetization free layer 11. The intermediate layer 30 includes a metal, an insulator or a semiconductor. For example, Cu, Au, Ag or the like may be used as the metal. In a case where the metal is used as the intermediate layer 30, the thickness of the intermediate layer 30 is, for example, about 1 nm or more and about 7 nm or less. For example, magnesium oxide (Mg—O, etc.), aluminum oxide (Al₂O₃, etc.), titanium oxide (Ti—O, etc.), zinc oxide (Zn—O, etc.), gallium oxide (Ga—O), or the like may be used as the insulator or the semiconductor. In a case where the insulator or the semiconductor is used as the intermediate layer 30, the thickness of the intermediate layer 30 is, for example, about 0.6 nm or more and about 2.5 nm or less.

The material of the magnetization free layer 11 (the first magnetic layer 10) may include at least one of Fe, Co and Ni, or an alloy including at least one thereof. Further, the material may be a material in which an additional element is added to the above-mentioned material.

Further, B, Al, Si, Mg, C, Ti, V, Cr, Mn, Cu, Zn, Ga, Zr, Hf or the like may be added to the above-mentioned metal or alloy as an additional element or an ultrathin layer.

Further, a crystalline magnetic layer may be used, or instead, an amorphous magnetization free layer may be used.

Further, a magnetic layer of an oxide or a nitride may be used.

The magnetization free layer 11 (the first magnetic layer 10) is formed of a material having a large absolute value of a magnetostriction constant. In such a case, the absolute value of the magnetostriction constant may be changed according to the type of the material, the additional element or the like. Further, magnetic strain may be greatly changed according to the material and configuration of the non-magnetic layer formed adjacent to the magnetic layer, other than the magnetic material. The absolute value of the magnetostriction constant may be larger than 10⁻², for example. In such a case, it is more favorable that the absolute value of the magnetostriction constant be larger than 10⁻⁵, for example.

As the absolute value of the magnetostriction constant increases, change in a magnetization direction due to a stress change may increase.

The magnetization free layer 11 (the first magnetic layer 10) may use a material having a positive magnetostriction constant, or may use a material having a negative magnetostriction constant.

The magnetization free layer 11 (the first magnetic layer 10) may include an alloy including at least one element selected from the group consisted of Fe, Co and Ni and boron (B). For example, the magnetization free layer 11 (the first magnetic layer 10) may include a Co—Fe—B alloy, an Fe—B alloy, an Fe—Co—Si—B alloy or the like. For example, the magnetization free layer 11 (the first magnetic layer 10) may include a Co₄₀Fe₄₀B₂₀ layer having a thickness of 4 nm.

The material of the magnetization free layer (the first magnetic layer) may include an FeCo alloy, an NiFe alloy or the like, for example. Alternatively, the material of the first magnetic layer and the second magnetic layer may include an Fe—Co—Si alloy, an Fe—Co—Si—B alloy, a Tb-M-Fe alloy (M being at least one selected from the group consisted of Sm, Eu, Gd, Dy, Ho and Er) indicating λs>100 ppm, a Tb-M1-Fe-M2 alloy (M1 being at least one selected from the group consisted of Sm, Eu, Gd, Dy, Ho and Er, and M2 being at least one selected from the group consisted of Ti, Cr, Mn, Co, Cu, Nb, Mo, W and Ta), an Fe-M3-M4-B alloy (M3 being at least one selected from the group consisted of Ti, Cr, Mn, Co, Cu, Nb, Mo, W and Ta and M4 being at least one selected from the group consisted of Ce, Pr, Nd, Sm, Tb, Dy and Er), Ni, Fe—Al, or ferrite (Fe₃O₄, (FeCo)₃O₄, or the like).

The magnetization free layer 11 (the first magnetic layer 10) may have a multilayered structure. The magnetization free layer 11 (the first magnetic layer 10) may have, for example, a two-layer structure. In a case where a tunneling insulating layer of MgO is used as the intermediate layer 30, it is favorable to provide a layer of a Co—Fe—B alloy on a contact interface with the intermediate layer 30. Thus, a high magnetoresistance effect is obtained. In such a case, a layer of a Co—Fe—B alloy may be provided on the intermediate layer 30; and an Fe—Co—Si—B alloy, an Fe—Ga alloy having a large Xs, an Fe—Co—Ga alloy, a Tb-M-Fe alloy (M being at least one selected from the group consisted of Sm, Eu, Gd, Dy, Ho and Er), a Tb-M1-Fe-M2 alloy (M1 being at least one selected from the group consisted of Sm, Eu, Gd, Dy, Ho and Er, and M2 being at least one selected from the group consisted of Ti, Cr, Mn, Co, Cu, Nb, Mo, W and Ta), an Fe-M3-M4-B ahoy (M3 being at least one selected from the group consisted of Ti, Cr, Mn, Co, Cu, Nb, Mo, W and Ta, and M4 being at least one selected from the group consisted of Ce, Pr, Nd, Sm, Tb, Dy and Er), Ni, Fe—Al, or ferrite (Fe₃O₄, (FeCo)₃O₄, or the like) may be formed on the layer of the Co—Fe—B alloy. For example, the magnetization free layer 11 includes Co₄₀Fe₄₀B₂₀/Fe₈₀Ga₂₀. The thickness of the Co₄₀Fe₄₀B₂₀, is, for example, 2 nm. The thickness of the Fe₈₀Ga₂₀ is, for example, 4 nm. For example, λs is greater than 100 ppm.

The capping layer 170 protects the layers provided under the capping layer 170. The capping layer 170 includes, for example, plural metal layers. The capping layer 170 includes, for example, a two-layer structure of a Ta layer and an Ru layer (Ta/Ru). The thickness of the Ta layer is, for example, 1 nm, and the thickness of the Ru layer is, for example, 5 nm. Other metal layers may be provided instead of the Ta layer or the Ru layer as the capping layer 170, The configuration of the capping layer 170 is arbitrary. The capping layer 170 may include, for example, a non-magnetic material. Other materials may be used as the capping layer 170 as long as the layers provided under the capping layer 170 can be protected.

FIG. 5B is a schematic perspective view illustrating another sensing element used in the embodiment. As illustrated in FIG. 5B, the sensing element 50B used in the pressure sensor according to the embodiment includes the lower electrode E1, the foundation layer 150, the magnetization free layer 11, the intermediate layer 30, the first magnetization fixed layer 21, the magnetic coupling layer 23, the second magnetization fixed layer 22, the pinning layer 160, the capping layer 170, and the upper electrode E2 arranged in order.

In the example, the magnetization free layer 11 corresponds to the first magnetic layer 10, and the first magnetization fixed layer 21 corresponds to the second magnetic layer 20, The sensing element 50B is a top spin-valve type element, Each of the layers included in the sensing element 50B may include the material described in the sensing element 50A, for example.

FIG. 5C is a schematic perspective view illustrating another sensing element used in the embodiment. As illustrated in FIG. 5C, the sensing element 50C used in the pressure sensor according to the embodiment includes the lower electrode E1, the foundation layer 150, a lower pinning layer 161, a lower second magnetization fixed layer 22a, a lower magnetic coupling layer 23a, a lower first magnetization fixed layer 21a, an intermediate layer 31, the magnetization free layer 11, an upper intermediate layer 32, an upper first magnetization fixed layer 21b, an upper magnetic coupling layer 23b, an upper second magnetization fixed layer 22b, an upper pinning layer 162, the capping layer 170, and the upper electrode E2 arranged in order.

The magnetization free layer 11 corresponds to the first magnetic layer 10, and at least one of the lower first magnetization fixed layer 21a and the upper first magnetization fixed layer 21b corresponds to the second magnetic layer 20. In the sensing element 50A and the sensing element SOB described above, the magnetization fixed layer is disposed at one surface of the magnetization free layer. In the sensing element 50C, the magnetization free layer is disposed between two magnetization fixed layers. The sensing element 50C is a dual spin-valve type element. Each of the layers included in the sensing element 50C may include the material described in the sensing element 50A, for example.

FIG. 5D is a schematic perspective view illustrating another sensing element used in the embodiment. As illustrated in FIG. 5D, the sensing element 50D used in the pressure sensor according to the embodiment includes the lower electrode E1, the foundation layer 150, the pinning layer 160, the magnetization fixed layer 24, the intermediate layer 30, the magnetization free layer 11, the capping layer 170, and the upper electrode E2 arranged in order.

The magnetization free layer 11 corresponds to the first magnetic layer 10, and the magnetization fixed layer 24 corresponds to the second magnetic layer 20. In the sensing elements 50A and 50B described above, a structure that uses the second magnetization fixed layer 22, the magnetic coupling layer 23, and the first magnetization fixed layer 21 is used. In the sensing element 50D, a single pinned structure that uses the single magnetization fixed layer 24 is used. Each of the layers included in the sensing element 50D may include the material described in the sensing element 50A, for example.

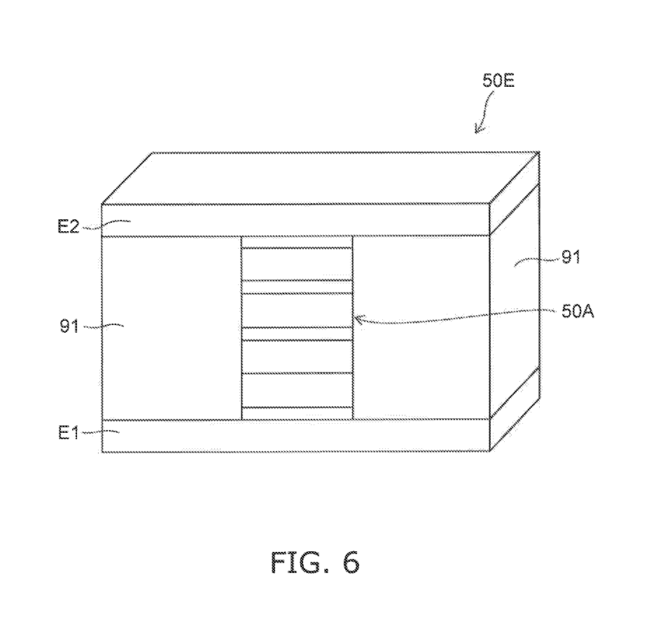

FIG. 6 is a schematic perspective view illustrating another sensing element used in the embodiment.

As illustrated in FIG. 6, an insulating layer 91 is provided in a sensing element 50E. That is, two insulating layers 91 (insulating portions) that are separated from each other are provided between the lower electrode E1 and the upper electrode E2, and the sensing element 50A is disposed between the two insulating layers 91. The sensing element 50A is disposed between the lower electrode E1 and the upper electrode E2. In the case of the sensing element 50A, the stacked body includes the foundation layer 150, the pinning layer 160, the second magnetization fixed layer 22, the magnetic coupling layer 23, the first magnetization fixed layer 21, the intermediate layer 30, the magnetization free layer 11, and the capping layer 170. In other words, the insulating layers 91 are provided to face the side walls of the sensing element 50A.

The insulating layers 91 may include, for example, aluminum oxide (e.g., Al₂O₃), silicon oxide (e.g., SiO₂), or the like. It is possible to suppress a leak current around the stacked body (in the example, the sensing element 50A) by the insulating layers 91, The insulating layers 91 may be applied to any of the sensing elements 50A to 50D.

In the sensing element 50, an “inverse-magnetostriction effect” acquired in the ferromagnet and an “MR effect” occurred in the sensing element 50 are used. The “inverse-magnetostriction effect” is obtained in the ferromagnetic layer used in the magnetization free layer. The “MR effect” occurs in the stacked film of the first magnetic layer, the intermediate layer, and the second magnetic layer.

The “inverse-magnetostriction effect” is a phenomenon in which the magnetization of a ferromagnet is changed by strain that occurs in the ferromagnet. In other words, when stress is applied to the sensing element 50, the magnetization direction of the first magnetic layer that is the magnetization free layer changes. As a result, the relative angle between the magnetization of the first magnetic layer and the magnetization of the second magnetic layer changes. The “MR effect” is a phenomenon in which when an external magnetic field is applied in a stacked film having a magnet, the value of electrical resistance in the stacked film is changed by the change of the magnetization of the magnet. The MR effect includes, for example, a giant magnetoresistance (GMR) effect, a tunneling magnetoresistance (TMR) effect, or the like. As a current flows in the sensing element 50, the change of the relative angle of the magnetization direction is read as the resistance change, so that the MR effect occurs. For example, the relative angle between the magnetization direction of the first magnetic layer that is the magnetization free layer of the sensing element 50 and the magnetization direction of the second magnetic layer is changed based on the strain applied to the sensing element 50. Here, the MR effect occurs due to the inverse-magnetostriction effect. When the resistance of a low resistance state is represented as R and variation of the electrical resistance changed by the MR effect is represented as ΔR, ΔR/R represents “MR change ratio”.

In a case where the ferromagnetic material used in the magnetization free layer has a positive magnetostriction constant, the direction of the magnetization changes so that the angle between the direction of the magnetization and the direction of a tensile strain becomes small and the angle between the direction of the magnetization and the direction of a compressive strain becomes large. In a case where the ferromagnetic material of the magnetization free layer has a negative magnetostriction constant, the direction of the magnetization changes so that the angle between the direction of the magnetization and the direction of the tensile strain becomes large and the angle between the direction of the magnetization and the direction of the compressive strain becomes small.

In a case where a combination of the materials of the stacked body of the magnetization free layer, the intermediate layer, and a reference layer (for example, magnetization fixed layer) has a positive magnetostriction constant, the electrical resistance decreases in a case where the relative angle between the magnetization free layer and the magnetization fixed layer is small. In a case where the combination of the materials of the stacked body of the magnetization free layer, the intermediate layer and the reference layer (for example, magnetization fixed layer) has a negative magnetostriction constant, the electrical resistance increases in a case where the relative angle between the magnetization free layer and the magnetization fixed layer is small.

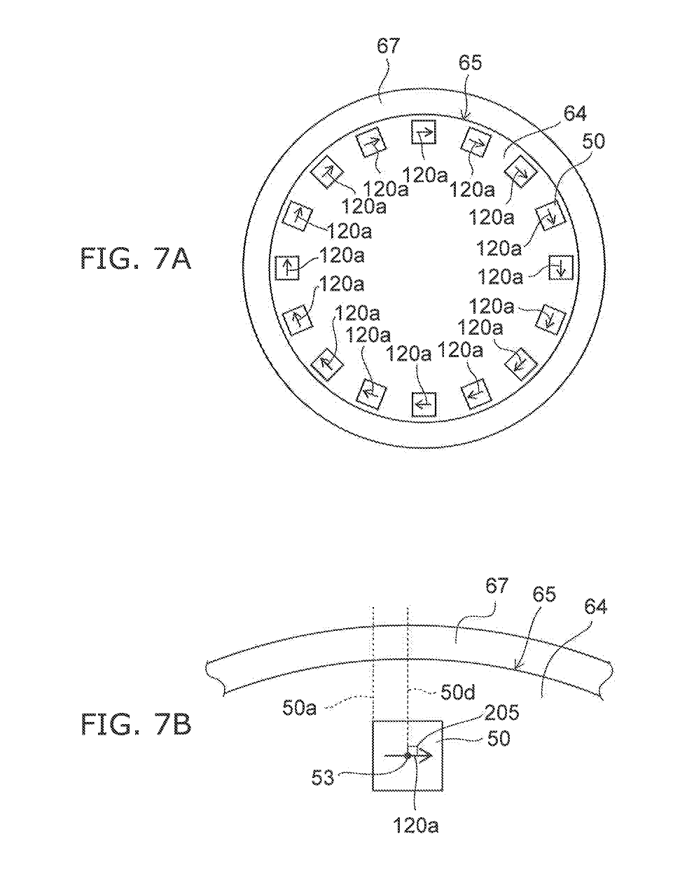

FIGS. 7A and 7B are schematic plan views illustrating a case where the sensing element has shape isotropy.

FIG. 7A is a schematic plan view illustrating a disposition example of the sensing element 50 on the film part 64 of the pressure sensor 310 according to the first embodiment.

In FIG. 7A, the circle illustrated in FIG. 2A is employed as a shape example of the film surface 641. Further, a shape that surrounds the entirety of the film part 64 is employed as an example of the shape of the fixing part 67. The plural sensing elements 50 are disposed along a boundary 65 (an edge portion 64c of the film part 64; see FIG. 1) between the film part 64 and the fixing part 67, In other words, the plural sensing elements 50 are disposed along a peripheral portion 70a (see FIG. 1) of the hollow part 70. In FIG. 7A, the sensing elements 50 may be disposed along the boundary 65 at an equal interval, but the sensing elements 50 may not be disposed at an equal interval.

The area of the sensing element 50 is sufficiently smaller than that of the film part 64, The length of one side of the sensing element 50 may be 0.5 μm or more and 20 μm or less.

FIG. 7B is a schematic plan view illustrating a positional relationship between the boundary 65 between the film part 64 and the fixing part 67, and the sensing element 50.

The plural sensing elements 50 are disposed so that an angle formed by a line 50d connecting a centroid 53 of the sensing element 50 and the boundary 65 in the shortest distance and one axis 50a (one side in the example) of the sensing element 50 is within a difference of 5° between at least two sensing elements among the plural sensing elements 50. In the example illustrated in FIGS. 7A and 7B, the angle formed by the line 50d connecting the centroid 53 of the sensing element 50 and the boundary 65 in the shortest distance and the one axis 50a of the sensing element 50 is parallel (0° or 180°). As illustrated in FIGS. 7A and 7B, the number of the sensing elements 50 in which the difference of the angles formed by the lines 50d connecting the centroids 53 of the sensing elements 50 and the boundary 65 in the shortest distance and the one axes 50a of the sensing elements 50 is within 5° is not limited to two elements at the positions that are symmetrical with respect to the centroid of the film part 64, and may be two or more elements at the positions that are not symmetrical with respect to the centroid of the film part 64. For example, the number of the sensing elements 50 may be three or more disposed in the circumferential direction of the film part 64.

Arrows illustrated in FIGS. 7A and 7B represent an example of the magnetization 120a of the magnetization fixed layer. An angle 205 formed by the line 50d connecting the centroid 53 of the sensing element 50 and the boundary 65 in the shortest distance and the magnetization 120a is within a difference of 5° between at least two sensing elements among the plural sensing elements 50. In the example illustrated in FIGS. 7A and 7B, the angle 205 formed by the line 50d connecting the centroid 53 of the sensing element 50 and the boundary 65 in the shortest distance and the magnetization 120a is 90°, As illustrated in FIGS. 7A and 7B, the number of the plural sensing elements 50 in which the difference of the angles 205 formed by the lines 50d connecting the centroids 53 of the sensing elements 50 and the boundary 65 in the shortest distance and the magnetizations 120a is within 5° is not limited to two elements at the positions that are symmetrical with respect to the centroid of the film part 64, and may be two or more elements at the positions that are not symmetrical with respect to the centroid of the film part 64. For example, the number of the sensing elements 50 may be three or more disposed in a row in the circumferential direction of the film part 64. Here, the magnetization 120a of the magnetization fixed layer is not limited thereto.

Here, when the pressure is applied to the film part 64, it is considered that strain occurs in a direction parallel to the line 50d connecting the centroid 53 of the sensing element 50 and the boundary 65 in the shortest distance.

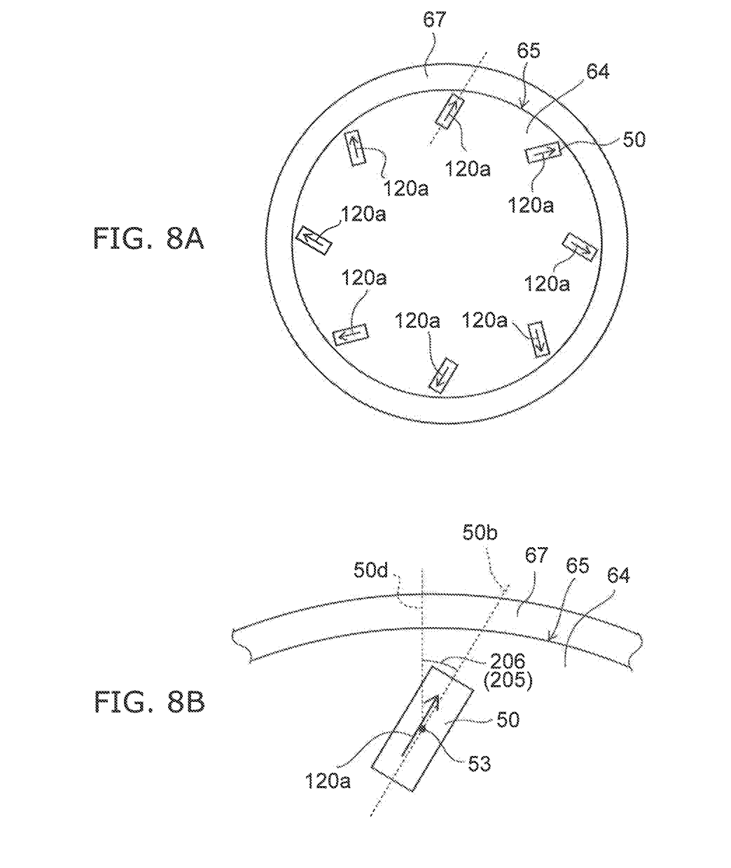

FIGS. 8A and 8B are schematic plan views illustrating a case where the sensing element has shape anisotropy.

FIG. 8A is a schematic plan view illustrating a disposition example of the sensing elements 50 on the film part 64 of the pressure sensor 310 according to the first embodiment.

In FIG. 8A, the circle illustrated in FIG. 2A is employed as a shape example of the film surface 64. Further, a shape that surrounds the entirety of the film part 64 is employed as an example of the shape of the fixing part 67. The plural sensing elements 50 are disposed along the boundary 65 between the film part 64 and the fixing part 67. In FIG. 8A, the sensing elements 50 may be disposed along the boundary 65 at an equal interval, but the sensing elements 50 may not be disposed at an equal interval.

FIG. 8B is a schematic plan view illustrating a positional relationship between the boundary 65 between the film part 64 and the fixing part 67, and the sensing element 50.

The plural sensing elements 50 are disposed so that an angle 206 formed by the line 50d connecting the centroid 53 of the sensing element 50 and the boundary 65 in the shortest distance and a long axis 50b of the sensing element 50 is within a difference of 5° between at least two sensing elements among the plural sensing elements 50. In the example illustrated in FIGS. 8A and 8B, the number of the plural sensing elements 50 in which the difference of the angles 206 formed by the lines 50d connecting the centroids 53 of the sensing elements 50 and the boundary 65 in the shortest distance and the long axes 50b of the sensing elements 50 is within 5° is not limited to two elements at the positions that are symmetrical with respect to the centroid of the film part 64, and may be two or more elements at the positions that are not symmetrical with respect to the centroid of the film part 64, For example, the number of the sensing elements 50 may be three or more disposed in a row in the circumferential direction of the film part 64.

Arrows illustrated in FIGS. 8A and 8B represent an example of the magnetization 120a of the magnetization fixed layer. The angle 205 formed by the line 50d connecting the centroid 53 of the sensing element 50 and the boundary 65 in the shortest distance and the magnetization 120a is within a difference of 5° between at least two sensing elements of the plural sensing elements 50. In the example illustrated in FIGS. 8A and 8B, the number of the sensing elements 50 in which the difference of the angles 205 formed by the lines 50d connecting the centroids 53 of the sensing elements 50 and the boundary 65 in the shortest distance and the magnetizations 120a is within 5° is not limited to two elements at the positions that are symmetrical with respect to the centroid of the film part 64, and may be two or more elements at the positions that are not symmetrical with respect to the centroid of the film part 64, For example, the number of the plural sensing elements 50 may be three or more disposed in a row in the circumferential direction of the film part 64, Here, the magnetization 120a of the magnetization fixed layer is not limited thereto.

Here, when the pressure is applied to the film part 64, it is considered that strain occurs in a direction parallel to the line 50d connecting the centroid 53 of the sensing element 50 and the boundary 65 in the shortest distance.

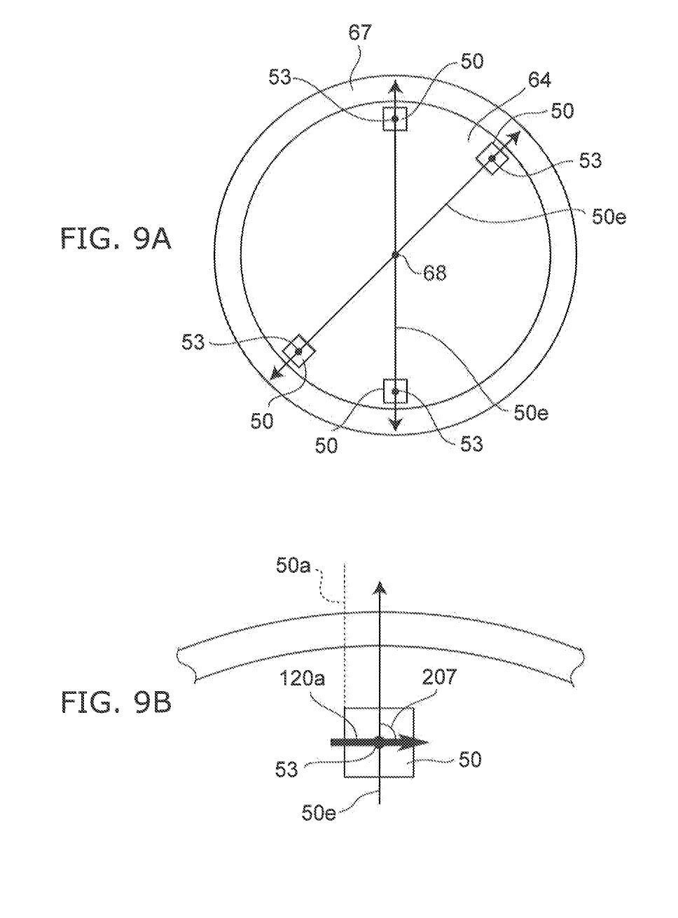

FIGS. 9A and 9B are schematic plan views illustrating a case where the sensing element has shape isotropy.

In FIGS. 9A and 9B, the circle illustrated in FIG. 2A is employed as a shape example of the film surface 64. Further, a shape that surrounds the entirety of the film part 64 is employed as an example of the shape of the fixing part 67.

FIG. 9A is a schematic plan view illustrating a line 50e connecting the centroid 53 of the sensing element 50 on the film part 64 of the pressure sensor 310 according to the first embodiment and a centroid 68 of the film part 64. For ease of description, the number of elements 50 shown in the figure is reduced. Further, in FIG. 9A, the elements 50 are disposed symmetrically with respect to the centroid 68, but may not be disposed symmetrically with respect to the centroid 68. The plural sensing elements 50 are disposed so that an angle formed by the line 50e connecting the centroid 53 of the sensing element 50 and the centroid 68 of the film part 64, and one axis 50a of the sensing element 50 is within a difference of 5° between at least two sensing elements among the plural sensing elements 50. In the example illustrated in FIGS. 9A and 9B, the angle formed by the line 50e connecting the centroid 53 of the sensing element 50 and the centroid 68 of the film part 64 and the one axis 50a of the sensing element 50 is parallel (0° or 180°). As illustrated in FIGS. 9A and 9B, the number of the sensing elements 50 in which the difference of the angles formed by the lines 50e connecting the centroids 53 of the sensing elements 50 and the centroid 68 of the film part 64, and the one axes 50a of the sensing elements 50 is within 5° is not limited to two elements at the positions that are symmetrical with respect to the centroid of the film part 64, and may be two or more elements at the positions that are not symmetrical with respect to the centroid of the film part 64. For example, the number of the sensing elements 50 may be three or more disposed in the circumferential direction of the film part 64.

Here, when the pressure is applied to the film part 64, it is considered that strain occurs in a direction parallel to the line 50e connecting the centroid 53 of the sensing element 50 and the centroid 68 of the film part 64.

FIG. 9B is a schematic plan view illustrating an angle 207 formed by the line 50e connecting the centroid 53 of the sensing element 50 and the centroid 68 of the film part 64, and the magnetization 120a of the magnetization fixed layer of the sensing element 50.

The plural sensing elements 50 are disposed so that the angle 207 formed by the line 50e connecting the centroid 53 of the sensing element 50 and centroid 68 of the film part 64, and the magnetization 120a of the magnetization fixed layer is within a difference of 5° between at least two sensing elements of the plural sensing elements 50 on the film part 64. In the example illustrated in FIGS. 9A and 9B, the angle 207 formed by the line 50e connecting the centroid 53 of the sensing element 50 and the centroid 68 of the film part 64, and the magnetization 120a of the magnetization fixed layer is 90°, As illustrated in FIGS. 9A and 9B, the number of the plural sensing elements 50 in which the difference of the angles 207 formed by the lines 50e connecting the centroids 53 of the sensing elements 50 and the centroid 68 of the film part 64, and the magnetization 120a of the magnetization fixed layer is within 5° is not limited to two elements at the positions that are symmetrical with respect to the centroid of the film part 64, and may be three or more disposed in a row in the circumferential direction of the film part 64.

Here, when the pressure is applied to the film part 64, it is considered that strain occurs in a direction parallel to the line 50e connecting the centroid 53 of the sensing element 50 and the centroid 68 of the film part 64.

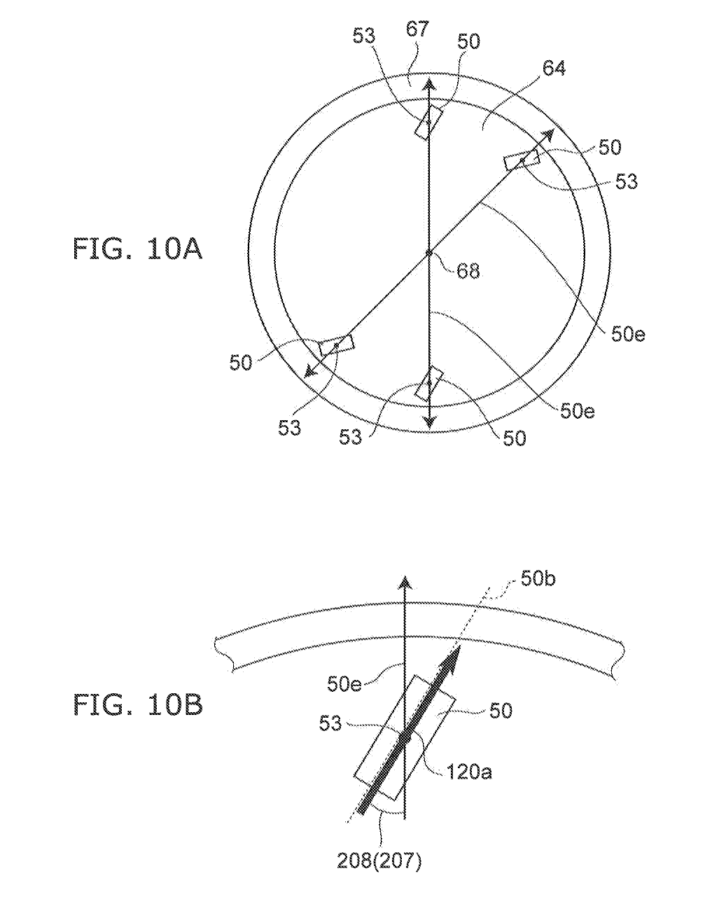

FIGS. 10A and 10B are schematic diagrams illustrating a case where the sensing element has shape anisotropy.

In FIGS. 10A and 10B, the circle illustrated in FIG. 2A is employed as a shape example of the film surface 64, Further, a shape that surrounds the entirety of the film part 64 is employed as an example of the shape of the fixing part 67.

FIG. 10A is a schematic plan view illustrating the line 50e connecting the centroid 53 of the sensing element 50 on the film part 64 of the pressure sensor 310 according to the first embodiment and the centroid 68 of the film part 64. For ease of description, the number of elements 50 in the figure is reduced. Further, in FIG. 10A, the elements 50 are disposed symmetrically with respect to the centroid 68, but may not be disposed symmetrically with respect to the centroid 68. The plural sensing elements 50 are disposed so that an angle 208 formed by the line 50e connecting the centroid 53 of the sensing element 50 and the centroid 68 of the film part 64, and the long axis 50b of the sensing element 50 is within a difference of 5° between at least two sensing elements of the plural sensing elements 50 on the film part 64. In the example illustrated in FIGS. 10A and 10B, the number of the plural sensing elements 50 in which the difference of the angles 208 formed by the lines 50e connecting the centroids 53 of the sensing elements 50 and the centroid 68 of the film part 64, and the long axes 50b of the sensing elements 50 is within 5° is not limited to two elements at the positions that are symmetrical with respect to the centroid of the film part 64, and may be two or more elements at the positions that are not symmetrical with respect to the centroid of the film part 64. For example, the number of the sensing elements 50 may be three or more disposed in a row in the circumferential direction of the film part 64.

Here, when the pressure is applied to the film part 64, it is considered that strain occurs in a direction parallel to the line 50e connecting the centroid 53 of the sensing element 50 and the centroid 68 of the film part 64.

FIG. 10B is a schematic plan view illustrating the angle 207 formed by the line 50e connecting the centroid 53 of the sensing element 50 and the centroid 68 of the film part 64, and the magnetization 120a of the magnetization fixed layer of the sensing element 50.

The plural sensing elements 50 are disposed so that the angle 207 formed by the line 50e connecting the centroid 53 of the sensing element 50 and centroid 68 of the film part 64, and the magnetization 120a of the magnetization fixed layer is within a difference of 5° between at least two sensing elements of the plural sensing elements 50 on the film part 64. In the example illustrated in FIGS. 10A and 10B, the number of the plural sensing elements 50 in which the difference of the angles 207 formed by the lines 50e connecting the centroids 53 of the sensing elements 50 and the centroid 68 of the film part 64, and the magnetization 120a of the magnetization fixed layer is within 5° is not limited to two elements at the positions that are symmetrical with respect to the centroid of the film part 64, and may be two or more elements at the positions that are not symmetrical with respect to the centroid of the film part 64. For example, the number of the sensing elements 50 may be three or more disposed in a row in the circumferential direction of the film part 64.

Here, when the pressure is applied to the film part 64, it is considered that strain occurs in a direction parallel to the line 50e connecting the centroid 53 of the sensing element 50 and the centroid 68 of the film part 64.

In a case where the sensing elements 50 have shape isotropy, the sensing elements 50 are disposed on the film surface 64 by a disposition method disclosed in any one of the disposition method described with reference to FIGS. 7A and 7B and the disposition method described with reference to FIGS. 9A and 9B.

In a case where the sensing elements 50 have shape anisotropy, the sensing elements 50 are disposed on the film surface 64 by a disposition method disclosed in any one of the disposition method described with reference to FIGS. 8A and 8B and the disposition method described with reference to FIGS. 10A and 10B.

As described later, in the disposition of the plural sensing elements 50 with respect to the film part 64 as illustrated in FIGS. 7A to 10B, an angle formed by a magnetization 110a of a magnetization free layer and the magnetization 120a of the magnetization fixed layer may be within a difference of 5° between at least two sensing elements among the plural sensing elements 50 on the film surface 64.

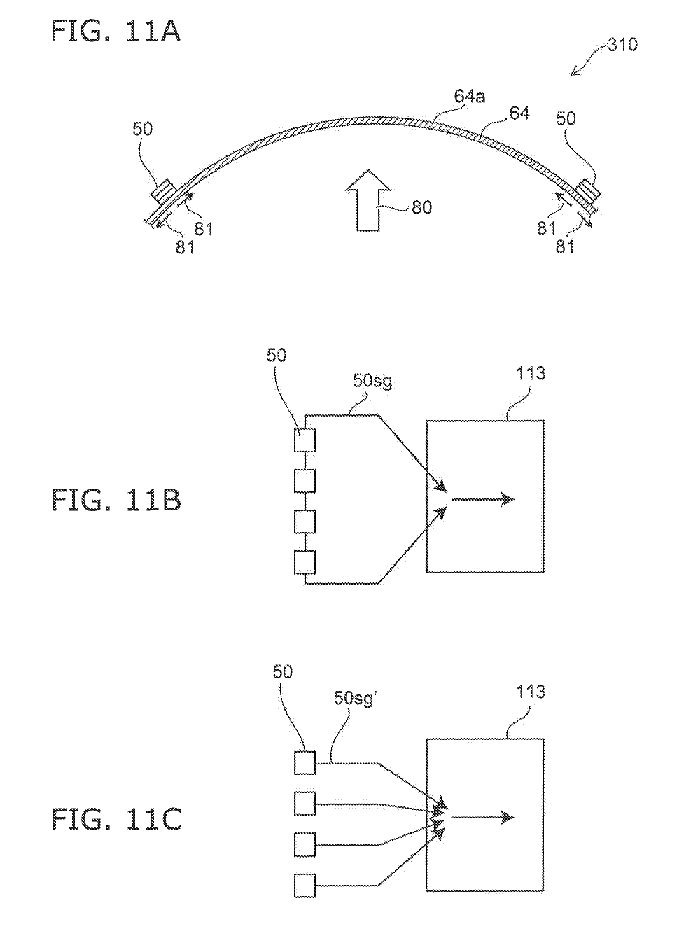

FIGS. 11A to 11C are schematic diagrams illustrating an operation of the pressure sensor according to the embodiment.

FIG. 11A is a schematic cross-sectional view of the portion including the film part 64. FIGS. 11B and 11C are schematic views illustrating signal processing of the pressure sensor 310, FIG. 11B is a schematic view illustrating a case where the plural sensing elements 50 are electrically connected in series. FIG. 11C is a schematic view illustrating a case where the plural sensing elements 50 are electrically connected in parallel.

First, as illustrated in FIG. 11A, when an external pressure 80 is applied, the film part 64 is bent by the external pressure 80. For example, the film part 64 is bent in an outwardly convex shape. If the film part 64 is bent in the outwardly convex shape, a stress 81 is applied to the sensing elements 50, In the case of FIG. 11A, tensile stress is applied to the sensing elements 50. If the film part 64 is bent in a concave shape, compressive stress is applied to the sensing elements 50.

If the stress 81 is applied to the sensing elements 50, the electrical resistance of the sensing elements 50 is changed according to the stress 81 due to the inverse-magnetostriction effect and the MR effect described above.

As illustrated in FIG. 11B, when the plural sensing elements 50 are connected in series, a signal 50sg of which a signal voltage is N times is transmitted to a processing circuit 113 as a signal variation, according to the number of elements N. Here, thermal noise and Schottky noise increase by a factor of √N with respect to the number N of elements. In other words, the signal-noise ratio (SNR) increases by the factor of √N using the sensing elements 50 of the number of elements N. By increasing the number N of the elements, it is possible to improve the SN ratio without increase in the size (diaphragm size) of the film part 64.

By using the disposition of the plural sensing elements 50 with respect to the film part 64 as illustrated in FIGS. 7A to 10B, it is possible to cause the direction of the strain applied to the sensing element 50 and the direction of the magnetization 120a of the second magnetic layer 20 to be the same in the plural sensing elements 50. Further, it is possible to cause the angle formed by the magnetization 110a of the magnetization free layer and the magnetization 120a of the magnetization fixed layer to be the same in the plural sensing elements 50. Thus, in the plural sensing elements 50 on the film part 64, it is possible to obtain the change of the electrical resistance due to the same MR effect. Thus, it is possible to dispose many sensing elements 50 along the boundary 65 between the film part 64 and the fixing part 67, as illustrated in FIG. 7A. Thus, it is possible to simply add each signal 50sg′ thereto. By using the disposition of the plural sensing elements 50 with respect to the film part 64 as illustrated in FIG. 7A to 10B, it is possible to cause the direction of the strain applied to the sensing element 50 and the direction of the magnetization 120a of the second magnetic layer 20 to be the same in the plural sensing elements 50. Thus, it is not necessary to perform a special process for the signal 50sg from the plural sensing elements 50 that are electrically connected in series. Thus, it is possible to increase the number N of elements, and to achieve improvement of the sensitivity of the pressure sensor 310.

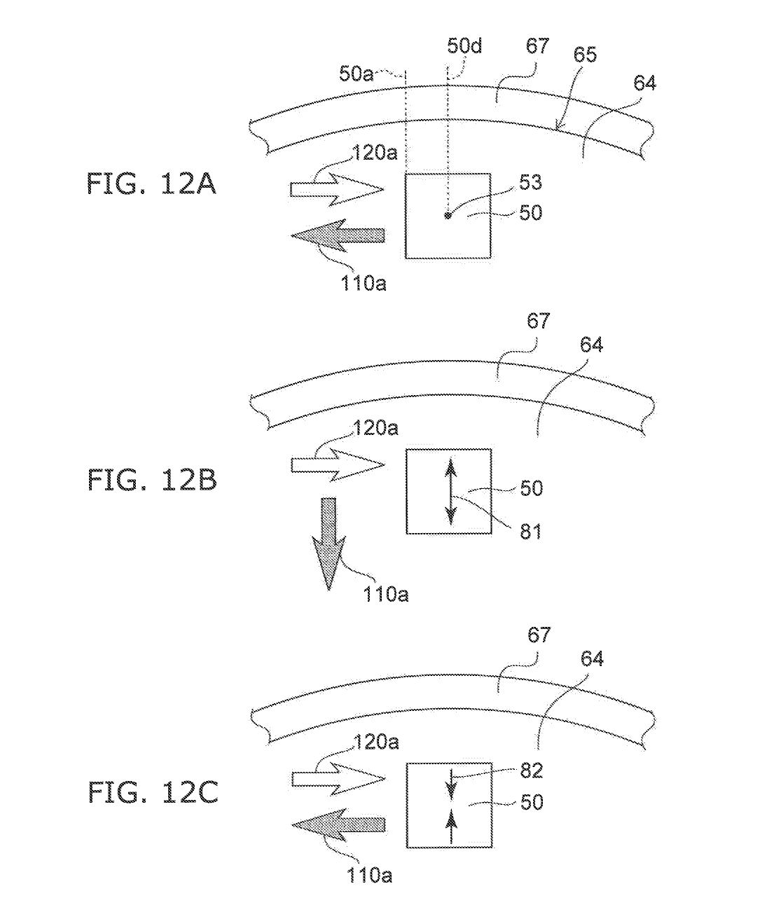

FIGS. 12A to 14C are schematic plan views illustrating change in magnetization with respect to stress.

FIGS. 12A to 14C are schematic plan views illustrating change in magnetization of the magnetization free layer with respect to stress and change in magnetization of the magnetization fixed layer with respect to stress.

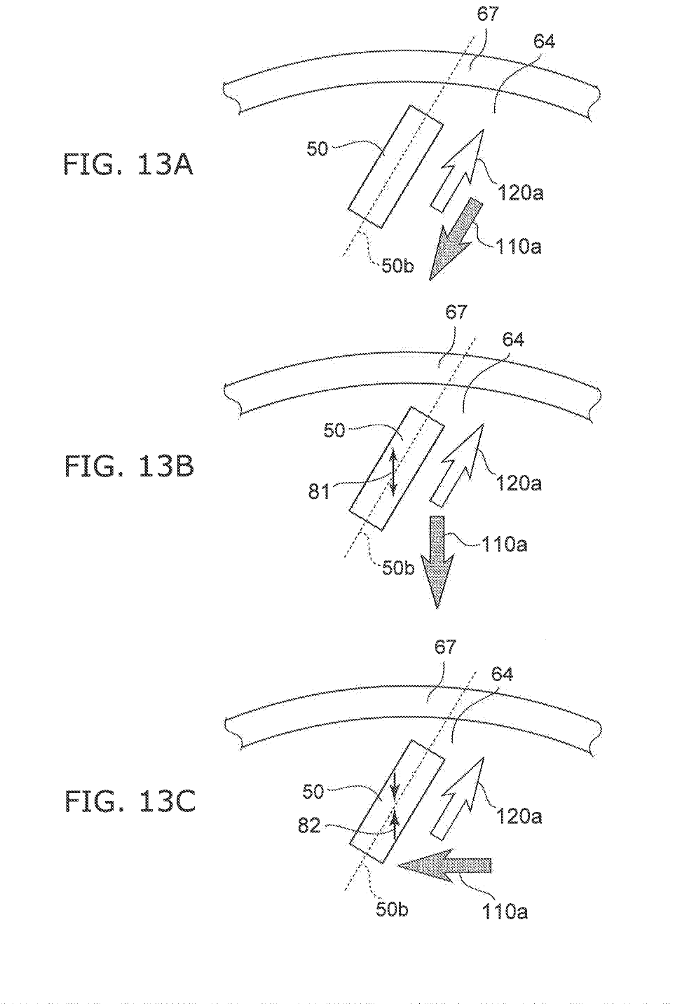

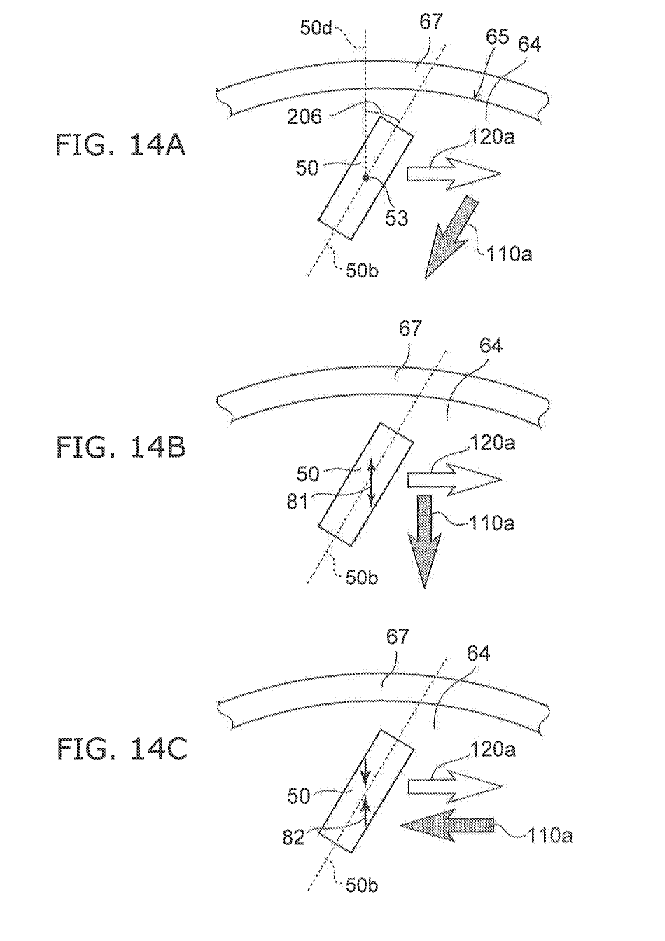

FIGS. 12A to 12C are schematic plan views illustrating change in magnetization in a sensing element that does not have shape anisotropy. FIGS. 13A to 14C are schematic diagrams illustrating change in magnetization in a sensing element that has shape anisotropy. A method for manufacturing the sensing elements 50 as illustrated in FIGS. 12A to 14C will be described later.

FIGS. 12A, 13A and 14A represent magnetization in the sensing element 50 in a case where the stress is not applied to the sensing element 50. FIGS. 12B, 13B and 14B represent magnetization in the sensing element 50 in a case where the tensile stress 81 is applied to the sensing element 50. FIGS. 12C, 13C, and 14C represent magnetization in the sensing element 50 in a case where the compressive stress 82 is applied to the sensing element 50.

In a case where the stress is not applied thereto, the relationship between the magnetization 110a of the magnetization free layer (for example, the first magnetic layer 10) and the magnetization 120a of the magnetization fixed layer (for example, the second magnetic layer 20) may be parallel or non-parallel due to selection of the materials of the magnetization free layer and the magnetization fixed layer or setting of the direction of the magnetization of the magnetization free layer. In FIGS. 12A and 13A, a case where the relationship between the magnetization 110a of the magnetization free layer and the magnetization 120a of the magnetization fixed layer is non-parallel will be described as an example.

As illustrated in FIG. 12B, when the tensile stress 81 is applied, a relative angle between the magnetization 110a of the magnetization free layer and the magnetization 120a of the magnetization fixed layer becomes small compared with a relative angle in the case of FIG. 12A. Thus, the electrical resistance is decreased due to the MR effect.

On the other hand, as illustrated in FIG. 12C, when the compressive stress 82 is applied, a relative angle between the magnetization 110a of the magnetization free layer and the magnetization 120a of the magnetization fixed layer is not changed from the relative angle in the case of FIG. 12A. Thus, the change in the electrical resistance due to the MR effect does not occur.

As illustrated in FIGS. 12A to 12C, the magnetization 120a of the magnetization fixed layer is perpendicular to one axis 50a of the sensing element 50. This is within a difference of 5° between at least two sensing elements among the plural sensing elements 50 on the film part 64. That is, the magnetization 120a of each magnetization fixed layer of the plural sensing elements 50 on the film part 64 is within 5° in the direction that is perpendicular to one axis 50a of the sensing element 50. In other words, the magnetization 120a of each magnetization fixed layer of the plural sensing elements 50 on the film part 64 is within 5° in the direction that is perpendicular to the line 50d connecting the centroid 53 of the sensing element 50 and the boundary 65 in the shortest distance. The angle formed by the line 50d connecting the centroid 53 of the sensing element 50 and the boundary 65 in the shortest distance, and the magnetization 120a of the magnetization fixed layer is within the difference of 5° between at least two sensing elements among the plural sensing elements 50 on the film part 64. The magnetizations 120a of at least two magnetization fixed layers among the plural sensing elements 50 on the film part 64 have different directions. That is, the direction of the magnetization 120a of the magnetization fixed layer of any one sensing element (first sensing element) among the plural sensing elements 50 on the film part 64 is different from the direction of the magnetization 120a of the magnetization fixed layer of the sensing element (second sensing element) that is any one sensing element of the plural sensing elements 50 on the film part 64, which is different from the first sensing element.

Accordingly, the angle formed by the magnetization 110a of the magnetization free layer and the magnetization 120a of the magnetization fixed layer is within the difference of 5° between at least two sensing elements among the plural sensing elements 50 on the film part 64. Thus, in the plural sensing elements 50 on the film part 64, it is possible to obtain change in the electrical resistance due to the same MR effect. Thus, as illustrated in FIG. 7A, it is possible to dispose many sensing elements 50 along the boundary 65 between the film part 64 and the fixing part 67. Thus, it is possible to increase the number N of elements, and to achieve improvement of the sensitivity of the pressure sensor 310.

When the sensing elements 50 have shape anisotropy, anisotropy also exists in the magnetization direction. In a case where the stress is not applied, the magnetization 110a of the magnetization free layer is directed along the long axis 50b. In FIGS. 13A to 13C, the magnetization 120a of the magnetization fixed layer is also fixed in the direction along the long axis 50b.

As illustrated in FIG. 13B, when the tensile stress 81 is applied, the relative angle formed by the magnetization 110a of the magnetization free layer and the magnetization 120a of the magnetization fixed layer changes from the relative angle of the case in FIG. 13A. Thus, change in the electrical resistance due to the MR effect occurs. This is similarly applied even to a case where the compressive stress 82 is applied, as illustrated in FIG. 13C.

As described above with reference to FIGS. 8A and 8B, the plural sensing elements 50 are disposed so that the angle 206 formed by the line 50d connecting the centroid 53 of the sensing element 50 and the boundary 65 in the shortest distance and the long axis 50b is within the difference of 5° between at least two sensing elements among the plural sensing elements 50 on the film part 64. As described above, the magnetization 120a of the magnetization fixed layer is fixed in the direction along the long axis 50b. Thus, the magnetizations 120a of at least two magnetization fixed layers among the plural sensing elements 50 on the film part 64 have different directions.

Accordingly, in the plural sensing elements 50 on the film part 64, it is possible to achieve change in the electrical resistance due to the same MR effect. Thus, as illustrated in FIG. 8A, it is possible to dispose many sensing elements 50 along the boundary 65 between the film part 64 and the fixing part 67. Thus, it is possible to increase the number N of elements, and achieve improvement of the sensitivity of the pressure sensor 301.

In the case of FIGS. 14A to 14C, differently from the case of FIGS. 13A to 13C, the magnetization 120a of the magnetization fixed layer is not directed along the long axis 50b.

As illustrated in FIG. 14B, when the tensile stress 81 is applied, compared with a case where the stress is not applied (case of FIG. 14A), the relative angle between the magnetization 110a of the magnetization free layer and the magnetization 120a of the magnetization fixed layer is reduced.

On the other hand, as illustrated in FIG. 14C, when the compressive stress 82 is applied, compared with a case where the stress is not applied (case of FIG. 14A), the relative angle between the magnetization 110a of the magnetization free layer and the magnetization 120a of the magnetization fixed layer is increased. In the case of the sensing element 50 illustrated in FIGS. 14A to 14C, as the stress changes from the compression stress to the tensile stress, the resistance of the sensing element 50 becomes small.

As described above with reference to FIGS. 8A to 8B, the plural sensing elements 50 are disposed so that the angle 206 formed by the line 50d connecting the centroid 53 of the sensing element 50 and the boundary 65 in the shortest distance and the long axis 50b is within the difference of 5° between at least two sensing elements among the plural sensing elements 50 on the film part 64, Thus, the magnetizations 120a of at least two magnetization fixed layers among the plural sensing elements 50 on the film part 64 have different directions.

Accordingly, in the plural sensing elements 50 on the film part 64, it is possible to achieve change in the electrical resistance due to the same MR effect. Thus, as illustrated in FIG. 8A, it is possible to dispose many sensing elements 50 along the boundary 65 between the film part 64 and the fixing part 67. Thus, it is possible to increase the number N of elements, and achieve improvement of the sensitivity of the pressure sensor 301.

### Second Embodiment

Next, a method for manufacturing the pressure sensor 310 will be described.

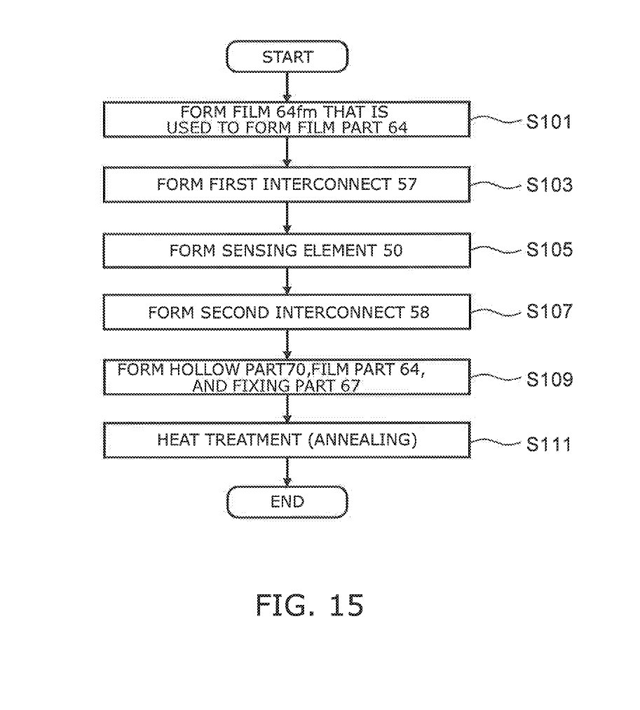

FIG. 15 is a flowchart illustrating a method for manufacturing a pressure sensor according to a second embodiment.

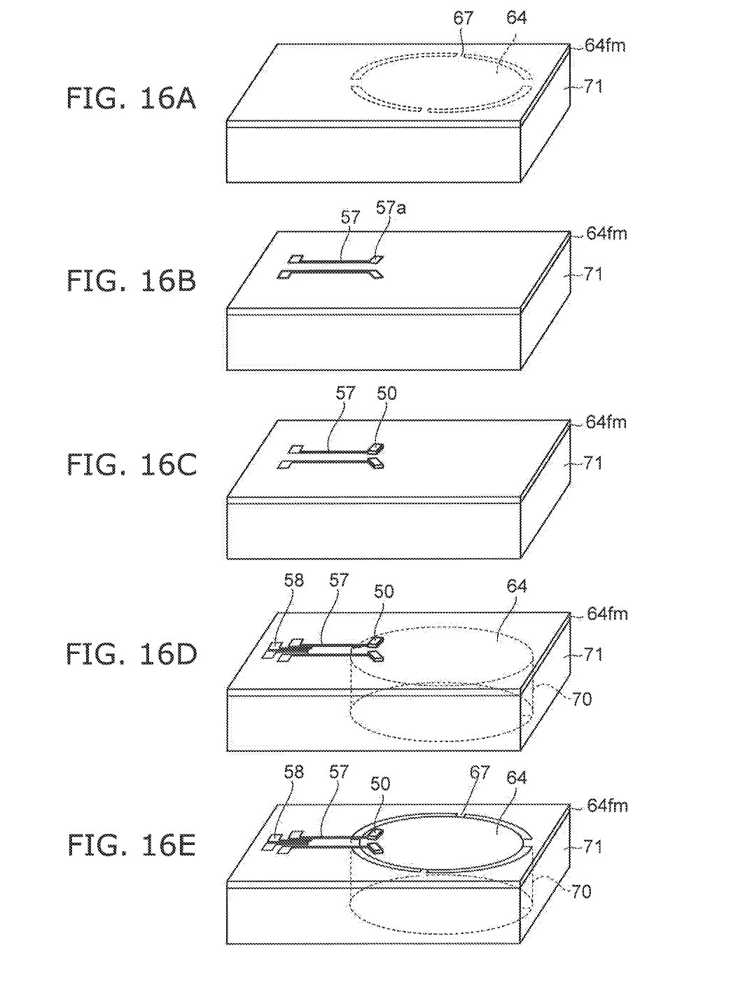

FIGS. 16A to 16E are schematic process diagrams illustrating the method for manufacturing the pressure sensor.

In FIGS. 16A to 16E, for ease of understanding, shapes and sizes of respective elements are appropriately modified from those illustrated in FIG. 1. Further, the shape of the film part 64 employs the circle as illustrated in FIG. 2A.

FIG. 16D illustrates a method for manufacturing the hollow part 70 to be formed from a rear surface of a substrate. In a case where the method is used, a system-in-package (SiP) configuration in which a circuit unit is formed as a separate chip and a pressure sensor and the circuit unit are formed as one package in a mounting process is used.

FIG. 16E illustrates a method for manufacturing the hollow part 70 to be formed from an upper portion of the substrate. In a case where the method is used, a system-on-chip (SoC) configuration in which a CMOS circuit or the like is provided in a lower portion of the substrate is used.

As illustrated in FIGS. 15 and 16A, a film 64fm that is used to form the film part 64 is formed (step S101). The film 64fm that is used to form the film part 64 is formed on the base unit 71, The base unit 71 includes, for example, a silicon substrate. The film 64fm includes, for example, a silicon oxide film. In a case where the fixing part 67 that fixes the film part 64 to the base unit 71 is formed, the fixing part 67 may be formed by patterning the film 64fm in this process. As the shape of the film surfaces 64a and 64b, the circle in FIG. 2A is employed in FIGS. 16A to 16E.

As illustrated in FIGS. 15 and 16B, the first interconnect 57 is formed (step S103). For example, as illustrated in FIG. 16B, a conductive film is formed on the film 64fm (or the film part 64), and is then patterned in a predetermined shape to form the first interconnect 57.

In FIG. 16B, for ease of understanding, a part of the plural first interconnects 57 are illustrated.

As illustrated in FIGS. 15 and 16C, the sensing element 50 is formed (step S105). For example, as illustrated in FIG. 16C, the sensing element 50 is formed on a pad 57a (see FIG. 16A) of the first interconnect 57. Films that serve as components that form the sensing element 50 are sequentially formed to form a stacked film. Further, the stacked film is patterned in a predetermined shape to form the sensing element 50.

As illustrated in FIGS. 15 and 16D, the second interconnect 58 is formed (step S107). For example, as illustrated in FIGS. 16D and 16E, an insulating film (not shown) is formed to cover the sensing element 50, and a part of the insulating film is removed to expose an upper surface of the sensing element 50. A conductive layer is formed thereon, and is then patterned in a predetermined shape to form the second interconnect 58.

At least a part of steps S101 to S107 may be simultaneously performed in a technically allowable range, or may be switched in order.

Then, as illustrated in FIGS. 15 and 16E, the hollow part 70, the film part 64 and the fixing part 67 are formed (step S109). For example, as illustrated in FIGS. 15D and 16E, an etching process is performed from the rear surface (lower surface) side of the base unit 71 to form the hollow part 70. A portion where the hollow part 70 is not formed becomes a non-hollow part, and the film part 64 and the fixing part 67 are formed therein.

The etching process may be performed using a deep reactive ion etching (RIE) process, a Bosch process or the like, for example.

Then, in order to create the sensing element 50 illustrated in FIGS. 12A to 14C, fixing of the magnetization 120a of the magnetization fixed layer due to annealing is performed (step S111).

Hereinafter, the method will be described.

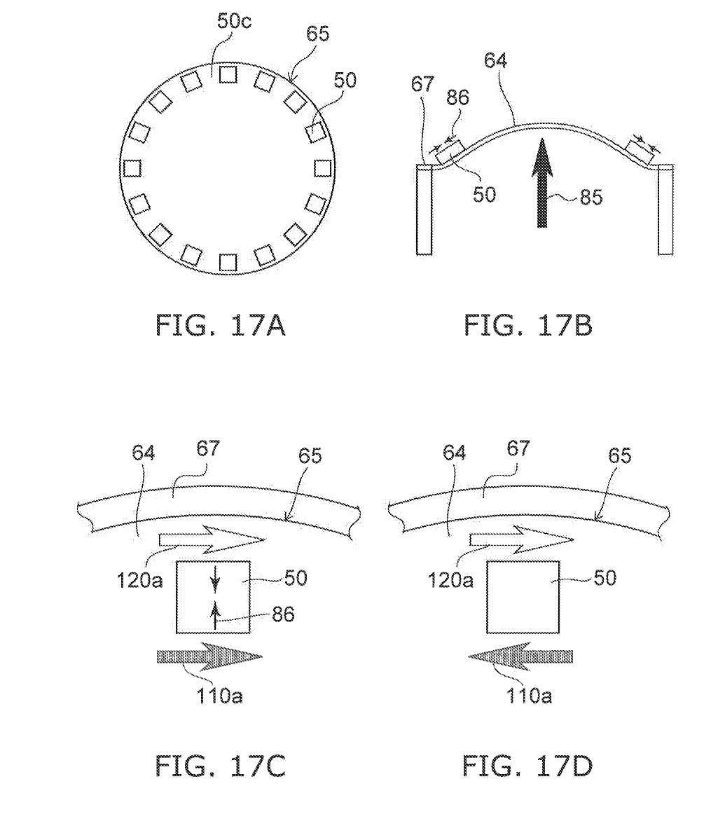

FIGS. 17A to 17D are schematic process diagrams illustrating the method for manufacturing the sensing element illustrated in FIGS. 12A to 12C.

FIGS. 17A to 17D are schematic process diagrams of the process of step S105 illustrated in FIG. 15.

As the shape of the film surfaces 64a and 64b, the circle in FIG. 2A is employed.

FIG. 17A is a schematic plan view illustrating the shape of a mask 51 on a stacked film 50c obtained by sequentially forming the films that serve as the components that form the sensing elements 50.

The square mask 51 having no shape anisotropy is formed around the boundary 65 between the film part 64 and the fixing part 67 after the sensing element 50 is formed. Thus, the sensing elements 50 having no shape anisotropy are formed around the boundary 65 through the etching process.

FIG. 17B is a schematic cross-sectional view illustrating the pressure sensor 310 while the magnetization fixing is performed due to annealing.

As in an external pressure 85 in FIG. 17B, by applying the external pressure 85 to the film surfaces 64a and 64b of the diaphragm from the side of the hollow part 70 of the diaphragm or the opposite side, a static strain is caused on the film surfaces 64a and 64b. As illustrated in FIG. 17B, in a case where the external pressure 85 is applied from the side of the hollow part 70 of the diaphragm, a compressive stress 86 occurs in the sensing element 50 formed around the boundary 65 between the film part 64 and the fixing part 67.

FIG. 17C is a schematic plan view illustrating the magnetization 110a of the magnetization free layer of the sensing element 50 during annealing and the magnetization 120a of the magnetization fixed layer of the sensing element during annealing.

During annealing, the static strain occurs in the diaphragm as described above, Thus, both of the magnetization 110a of the magnetization free layer and the magnetization 120a of the magnetization fixed layer before the magnetization fixing are changed due to the inverse-magnetostriction effect. Whether the magnetization is directed in a direction parallel with or in a direction perpendicular to the direction of the stress 86 is selectable according to selection of the material of the magnetic layer. In FIG. 17C, a case where the magnetization is directed in the direction perpendicular to the compressive stress 86 is employed.

FIG. 17D is a schematic plan view illustrating the magnetization 110a of the magnetization free layer after the stress 86 is removed and the magnetization 120a of the magnetization fixed layer after the stress 86 is removed, after the magnetization fixing.

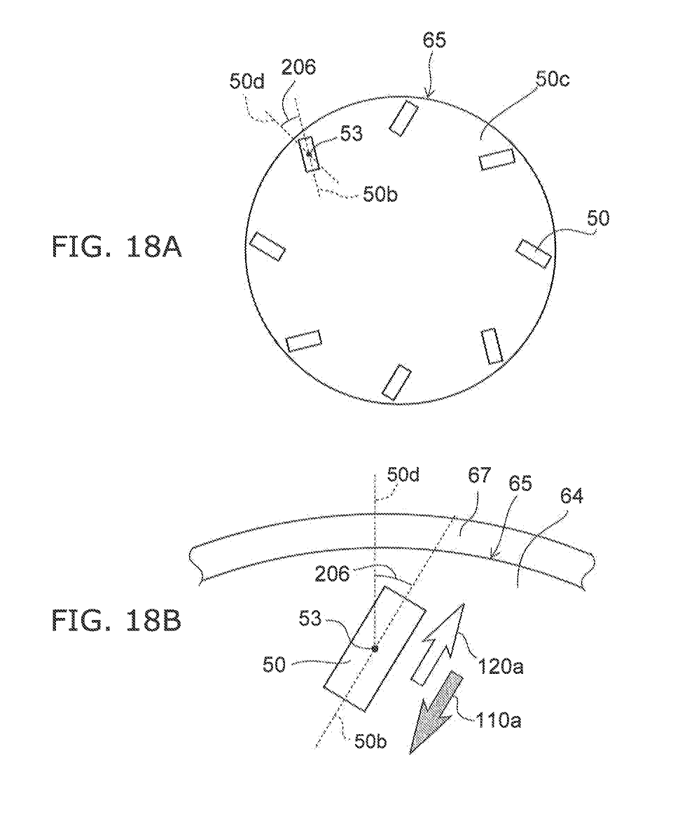

The magnetization 120a of the magnetization fixed layer is fixed in a direction based on the inverse-magnetostriction effect during annealing. On the other hand, the inverse-magnetostriction effect disappears as the stress 86 is removed, and the magnetization 110a of the magnetization free layer is directed in an antiparallel direction with respect to the magnetization 120a of the magnetization fixed layer. In a case where the stress is not applied, the relationship between the magnetization 110a and the magnetization 120a of the magnetization fixed layer may be selectively parallel or antiparallel according to selection of the materials or application of an external magnetic field after annealing. Similar to FIGS. 12A and 13A, the antiparallel is employed in FIGS. 17D and 18B.

FIGS. 18A and 18B are schematic process diagrams illustrating the method for manufacturing the sensing element illustrated in FIGS. 13A to 13C.

FIGS. 18A and 18B are schematic process diagrams of the process in step S105 illustrated in FIG. 15.

As the shape of the film surfaces 64a and 64b, the circle in FIG. 2A is employed.

FIG. 18A is a plan view illustrating the shape of a mask 52 on the stacked film 50c obtained by sequentially forming the films that serve as the components that form the sensing elements 50.

The rectangular mask 52 having shape anisotropy is formed around the boundary 65 between the film part 64 and the fixing part 67. Here, the mask 52 is formed so that the angle 206 formed by the line 50d connecting the centroid 53 of the sensing element 50 and the boundary 65 in the shortest distance and the long axis 50b is within a difference of 5° between at least two masks among the plural masks 52 on the film part 64. After forming the masks 52, the sensing elements 50 having shape anisotropy are formed around the boundary 65 by the etching process.

FIG. 18B is a schematic plan view illustrating the magnetization 110a of the magnetization free layer and the magnetization 120a of the magnetization fixed layer in a case where the sensing element 50 is formed by the method illustrated in FIG. 18A.

As described above, in a case where the sensing element 50 has shape anisotropy, the magnetization of the magnetic layer is directed in the direction along the long axis 50b of the sensing element 50. Thus, the magnetization 110a of the magnetization free layer and the magnetization 120a of the magnetization fixed layer are directed in an antiparallel direction along the long axis 50b.

Here, the directions of the magnetization 110a of the magnetization free layer and the magnetization 120a of the magnetization fixed layer are not determined in the forming stage of the sensing element 50. Thus, the magnetization of each magnetic layer may be opposite to the case of FIG. 18B.

By performing the annealing and the magnetization fixing for the sensing element 50 in the state of FIG. 18B, it is possible to form the sensing element 50 illustrated in FIGS. 13A to 13C.

In a case where the stress is not applied after annealing, the relationship between the magnetization 110a of the magnetization free layer and the magnetization 120a of the magnetization fixed layer may be selectively parallel or antiparallel according to selection of the materials or application of an external magnetic field after annealing.

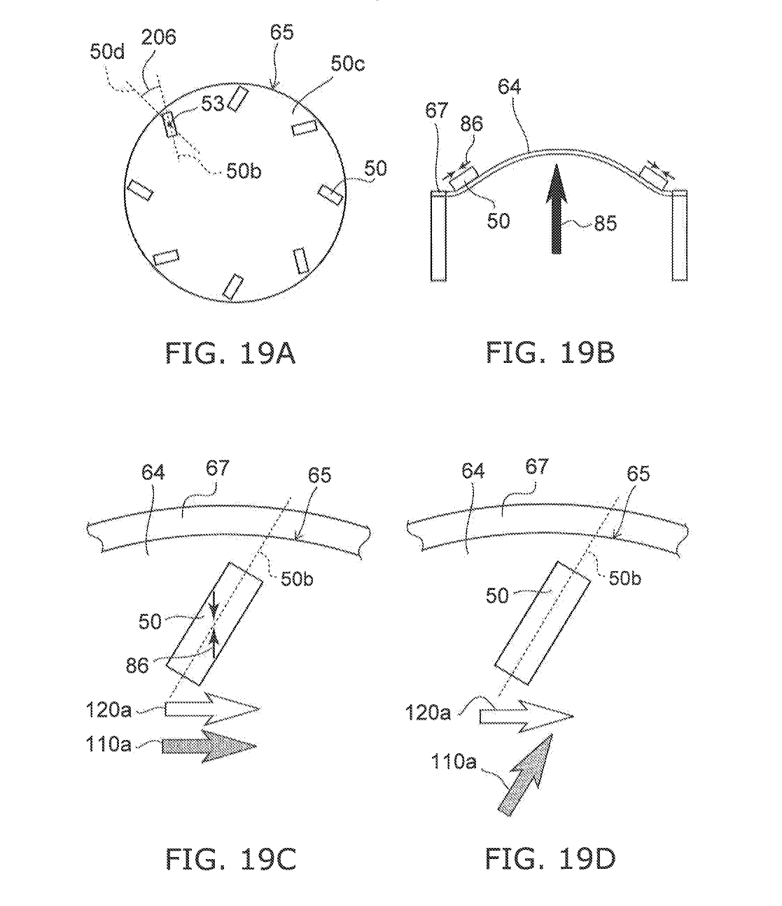

FIGS. 19A to 19D are schematic process diagrams illustrating the method for manufacturing the sensing element illustrated in FIGS. 14A to 14C.

FIGS. 19A to 19D are schematic process diagrams of the process in step S105 illustrated in FIG. 15.

As the shape of the film surfaces 64a and 64b, the circle in FIG. 2A is employed.

FIG. 19A is a schematic plan view illustrating the shape of a mask 52 on the stacked film 50c obtained by sequentially forming the films that serve as the components that form the sensing elements 50.

The rectangular mask 52 having shape anisotropy is formed around the boundary 65 between the film part 64 and the fixing part 67. Here, the mask 52 is formed so that the angle 206 formed by the line 50d connecting the centroid 53 of the sensing element 50 and the boundary 65 in the shortest distance and the long axis 50b is within a difference of 5° between at least two masks among the plural masks 52 on the film part 64. After forming the masks 52, the sensing elements 50 having shape anisotropy are formed around the boundary 65 by the etching process.

FIG. 19B is a schematic cross-sectional view illustrating the pressure sensor 310 while the magnetization fixing is performed due to annealing.

As in an external pressure 85 in FIG. 19B, by applying the external pressure 85 to the film surfaces 64a and 64b of the diaphragm from the side of the hollow part 70 of the diaphragm or the opposite side, a static strain is caused on the film surfaces 64a and 64b. As illustrated in FIG. 19B, in a case where the external pressure 85 is applied from the side of the hollow part 70 of the diaphragm, a compressive stress 86 occurs in the sensing element 50 formed around the boundary 65 between the film part 64 and the fixing part 67.

FIG. 19C is a schematic plan view illustrating the magnetization 110a of the magnetization free layer of the sensing element 50 during annealing and the magnetization 120a of the magnetization fixed layer of the sensing element 50 during annealing.

During annealing, the static strain occurs in the diaphragm as described above. Thus, both of the magnetization 110a of the magnetization free layer and the magnetization 120a of the magnetization fixed layer before the magnetization fixing are changed due to the inverse-magnetostriction effect. Whether the magnetization is directed in a direction parallel with or in a direction perpendicular to the direction of the stress 86 is selectable according to selection of the material of the magnetic layer or application of an external magnetic field after annealing. In FIG. 19C, a case where the magnetization is directed in the direction perpendicular to the compressive stress 86 is employed.

FIG. 19D is a schematic plan view illustrating the magnetization 110a of the magnetization free layer after the stress 86 is removed and the magnetization 120a after the stress 86 is removed, after the magnetization fixing.

The magnetization 120a of the magnetization fixed layer is fixed in a direction based on the inverse-magnetostriction effect during annealing. On the other hand, the inverse-magnetostriction effect disappears as the stress 86 is removed, and the magnetization 110a of the magnetization free layer is directed in the direction along the long axis 50b of the sensing element 50 due to magnetic anisotropy.

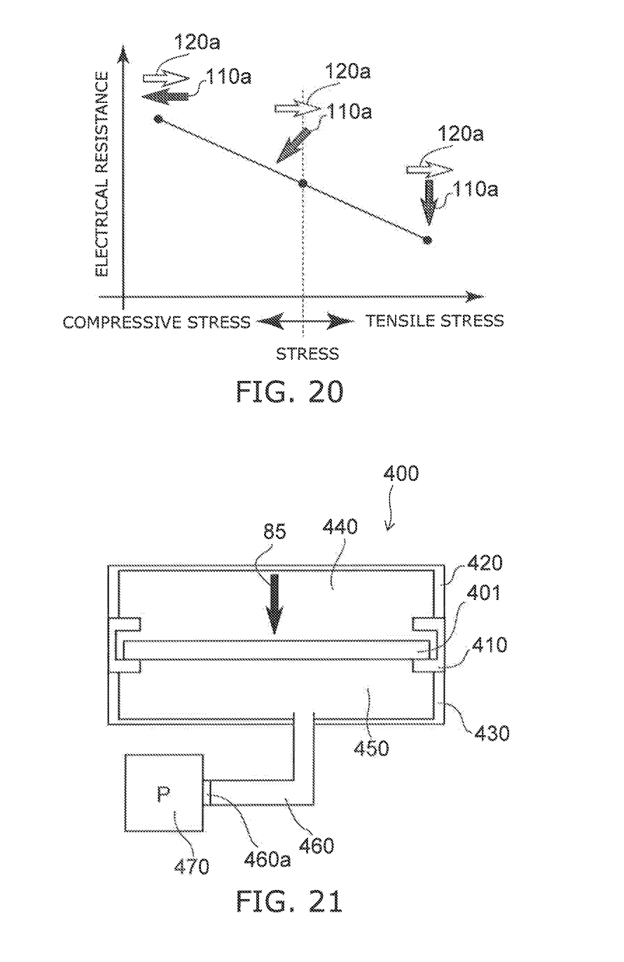

FIG. 20 is a graph illustrating the relationship between the stress applied to the sensing element illustrated in FIGS. 14A to 14C and the electrical resistance.

FIG. 20 is a graph illustrating change in the electrical resistance in a case where each of the compressive stress and the tensile stress is applied to the sensing element 50 formed by the process described above with reference to FIGS. 19A to 19D.

Whether the electrical resistance becomes low when the magnetization 110a of the magnetic free layer and the magnetization 120a of the magnetization fixed layer are parallel with each other or when the magnetization 110a of the magnetic free layer and the magnetization 120a of the magnetization fixed layer are antiparallel with each other is selectable according to selection of the materials of the first magnetic layer 10, the second magnetic layer 20 and the intermediate layer 30 of the sensing element 50. In FIG. 20, a case where the magnetization 110a of the magnetization free layer and the magnetization 120a of the magnetization fixed layer are antiparallel with each other and the electrical resistance becomes high is employed.

As illustrated in FIG. 14B, in a case where the tensile stress 81 is applied to the sensing element 50, a relative angle 200b between the magnetization 110a of the magnetization free layer and the magnetization 120a of the magnetization fixed layer becomes small compared with a relative angle 200c in a case where the stress 81 is not applied, and the electrical resistance becomes low due to the MR effect.

On the other hand, as illustrated in FIG. 14C, in a case where the compressive stress 82 is applied to the sensing element 50, the relative angle 200b between the magnetization 110a of the magnetization free layer and the magnetization 120a of the magnetization fixed layer becomes zero and becomes large compared with the relative angle 200c in a case where the stress 82 is not applied, and thus, the electrical resistance becomes high due to the MR effect.

As described above, in the sensing element 50 formed by the process described above with reference to FIGS. 19A to 19D as illustrated in FIG. 20, the value of the electrical resistance becomes high as the direction of the applied stress changes from the compressive stress to the tensile stress.

### Third Embodiment

As illustrated in FIGS. 17B and 19B, an apparatus for performing annealing in a state where the stress is applied to the diaphragm will be described.

FIG. 21 is a schematic cross-sectional view illustrating a manufacturing apparatus of a pressure sensor according to a third embodiment.

FIG. 21 is a schematic cross-sectional view illustrating an apparatus for performing external pressure control based on decompression suction with respect to the pressure sensor.

A manufacturing apparatus 400 of the pressure sensor illustrated in FIG. 21 includes a first jig 410, a second jig 420, a third jig 430, a cylindrical tube 460, and a vacuum pump (pressure difference generator) 470.

As illustrated in FIG. 21, a substrate 401 for which the processes up to step S105 in FIG. 15 are performed and on which the pressure sensor 310 is formed is fixed by the first jig 410. Further, the second jig 420 is mounted on the first jig 410 to form a space 440 (a first space). The third jig 430 is mounted under the first jig 410 to form a space 450 (a second space).

The cylindrical tube 460 for mounting the vacuum pump 470 is provided to the third jig 430. After the vacuum pump 470 is operated to suction gas (for example, air) in the space 450, a connection part 460a of the cylindrical tube 460 and the vacuum pump 470 is sealed, and thus, a difference between degrees of vacuum is caused between the space 440 and the space 450 to generate the external pressure 85.

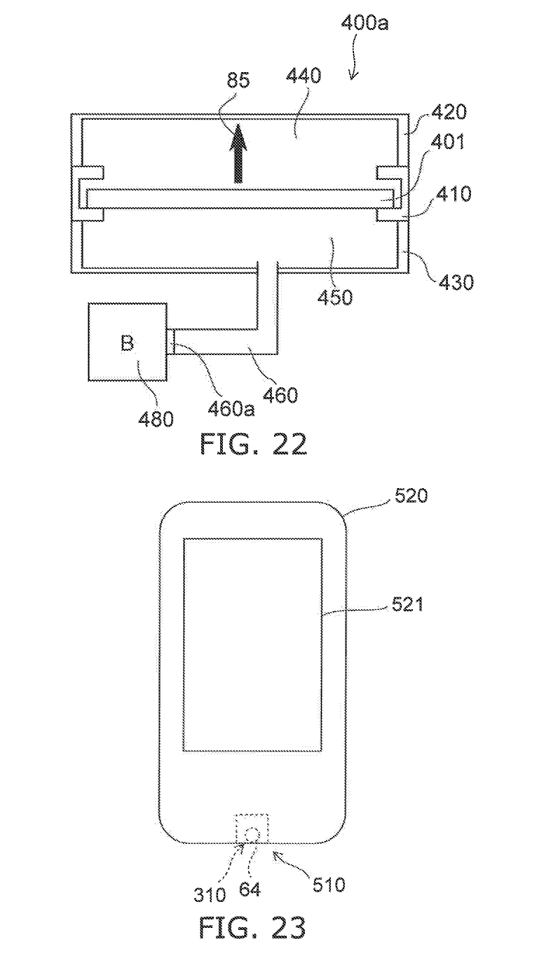

FIG. 22 is a schematic cross-sectional view illustrating another manufacturing apparatus of the pressure sensor according to the third embodiment.

FIG. 22 is a schematic cross-sectional view illustrating an apparatus for performing external pressure control based on pressure discharge with respect to the pressure sensor.

A manufacturing apparatus 400a of the pressure sensor in FIG. 22 includes the first jig 410, the second jig 420, the third jig 430, the cylindrical tube 460, and a container 480 such as a cylinder, for example. As illustrated in FIG. 22, a substrate 401 for which the processes up to step S105 in FIG. 15 are performed and on which the pressure sensor 310 is formed is fixed by the first jig 410. Further; the second jig 420 is mounted on the first jig 410 to form a space 440 (a first space). The third jig 430 is mounted under the first jig 410 to form a space 450 (a second space).

The cylindrical tube 460 for mounting the container 480 is provided to the third jig 430. After the container 480 (pressure difference generator; for example, high pressure cylinder) is operated to discharge gas (for example, air) in the space 450, a connection part 460a of the cylindrical tube 460 and the container 480 is sealed, and thus, a pressure difference is caused between the space 440 and the space 450 to generate the external pressure 85. An inert gas such as Ar, Xe, Kr or N₂ may be inserted into the space 450 to form a positive pressure, and then, the connection part 460a between the cylindrical tube 460 and the container 480 may be sealed.

In the manufacturing apparatus 400 in FIG. 21 and the manufacturing apparatus 400a in FIG. 22, in order to prevent breakage of the film part 64, the size of the external pressure 85 is set to 30 KPa (kilopascals) or less.

By inserting the manufacturing apparatus 400 in which the connection part 460a is sealed into an annealing apparatus to perform annealing, it is possible to perform the annealing in a state where a static strain is caused on the film surfaces 64a and 64b of the pressure sensor 310. Here, a heater may be directly provided to the manufacturing apparatus 400 to form an annealing apparatus.

In the above-described manufacturing apparatuses in FIGS. 21 and 22, an example in which the sealing is performed in a state where the space 450 is decompressed or pressurized is described, but as long as the pressure difference between the space 440 and the space 450 can be controlled, heat treatment may be performed in a state where the suction due to the pump or the discharge due to the container 480 are continuously performed.

It is favorable that the annealing temperature be equal to or higher than the blocking temperature of the antiferromagnetic material used in the pinning layer 160. Further, in a case where an antiferromagnetic layer including Mn is used, it is favorable that the annealing temperature be equal to or lower than a temperature at which the diffusion of Mn occurs. For example, the annealing temperature may be set to 200° C. or higher and 500° C. or lower. In such a case, favorably, the annealing temperature may be set to 250° C. or higher and 400° C. or lower.

In order to fix magnetization of the ferromagnetic layer being in contact with the pinning layer 160, the heat treatment is performed while the magnetic field is applied. The magnetization of the ferromagnetic layer being in contact with the pinning layer 160 is fixed in the direction of the magnetic field applied in the heat treatment. The annealing temperature is set to be equal to or higher than the blocking temperature of the antiferromagnetic material used in the pinning layer, for example. Further, when an antiferromagnetic layer including Mn is used, it is favorable that the annealing temperature be equal to or lower than a temperature at which the diffusion of Mn occurs. For example, the annealing temperature may be set to 200° C. or higher and 500° C. or lower. Favorably, the annealing temperature may be set to 250° C. or higher and 400° C. or lower.

### Fourth Embodiment

FIG. 23 is a schematic plan view illustrating a microphone according to a fourth embodiment.

As illustrated in FIG. 23, a microphone 510 includes any pressure sensor 310 according to the respective embodiments described above or a pressure sensor according to a modification of these pressure sensors. Hereinafter, the microphone 510 that includes the pressure sensor 310 will be described as an example.

The microphone 510 is embedded in an end portion of a personal digital assistant 520. The film part 64 of the pressure sensor 310 provided in the microphone 510 may be substantially parallel to, for example, a surface of the personal digital assistant 520 where a display unit 521 is provided. The disposition of the film part 64 is not limited to the above illustration and may be appropriately modified.

Since the microphone 510 includes the pressure sensor 310 or the like, it is possible to achieve high sensitivity with respect to frequencies in a wide band.

Further, a case where the microphone 510 is embedded in the personal digital assistant 520 is illustrated, this is not limitative. The microphone 510 may also be embedded in, for example, an IC recorder, a pin microphone, or the like.

### Fifth Embodiment

The embodiment relates to an acoustic microphone using the pressure sensor of the embodiments described above.

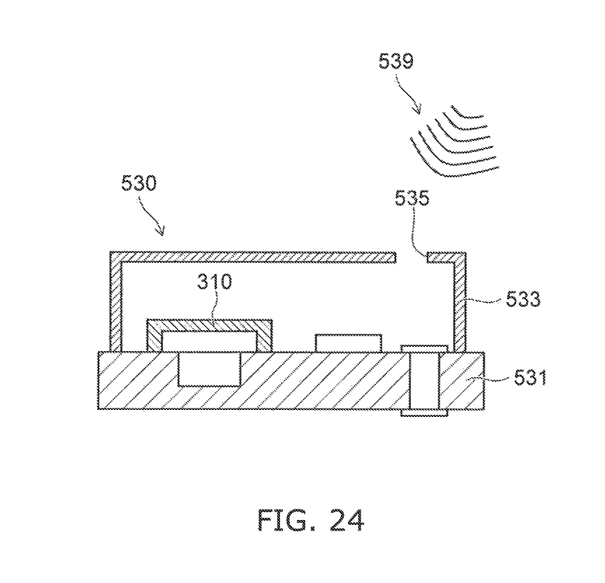

FIG. 24 is a schematic cross-sectional view illustrating the acoustic microphone according to a fifth embodiment.

According to the embodiment, an acoustic microphone 530 includes a printed circuit board 531, a cover 533, and the pressure sensor 310. The printed circuit board 531 includes, for example, a circuit such as an amplifier. An acoustic hole 535 is provided in the cover 533. Sound 539 passes through the acoustic hole 535 to enter the inside of the cover 533.

Any of the pressure sensors described in regard to the embodiments described above or a pressure sensor according to a modification of these pressure sensors may be used as the pressure sensor 310.

The acoustic microphone 530 responds to sound pressure. The acoustic microphone 530 of high sensitivity is obtained by using the pressure sensor 310 of high sensitivity. For example, the pressure sensor 310 is mounted on the printed circuit board 531, and then, electrical signal lines are provided. The cover 533 is provided on the printed circuit board 531 to cover the pressure sensor 310.

According to the embodiment, it is possible to provide an acoustic microphone of high sensitivity.

### Sixth Embodiment

The embodiment relates to a blood pressure sensor using the pressure sensor of the embodiments described above.

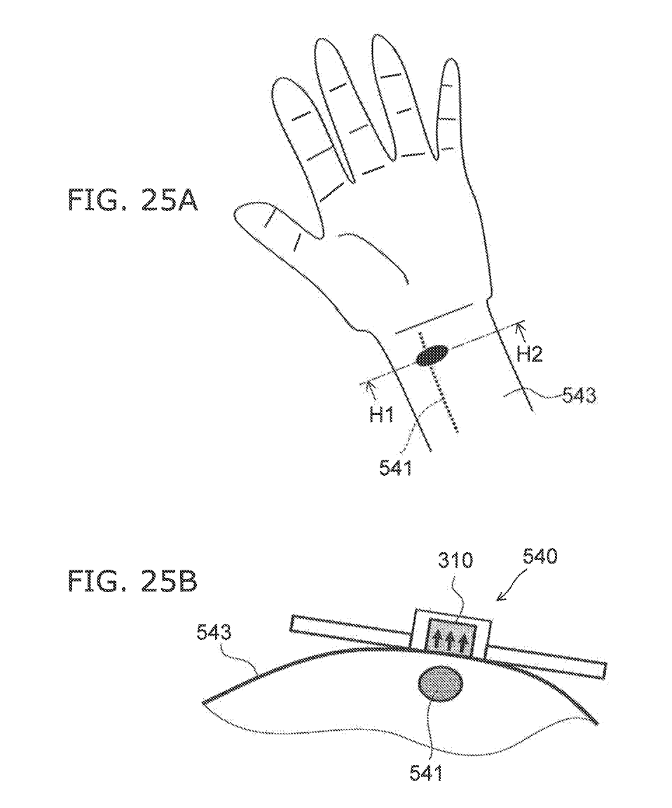

FIGS. 25A and 25B are schematic views illustrating the blood pressure sensor according to a sixth embodiment.

FIG. 25A is a schematic plan view illustrating the skin on the arterial vessel of a human. FIG. 25B is a cross-sectional view along line H1-H2 of FIG. 25A.

In the embodiment, the pressure sensor 310 is used as a blood pressure sensor 540. The pressure sensor 310 includes any of the pressure sensors described in regard to the embodiments described above or a pressure sensor according to a modification of these pressure sensors.

Thus, it is possible to perform highly-sensitive pressure sensing by a small pressure sensor. The blood pressure sensor 540 can perform a continuous blood pressure measurement by the pressure sensor 310 being pressed onto a skin 543 on an arterial vessel 541.

According to the embodiment, it is possible to provide a blood pressure sensor of high sensitivity.

### Seventh Embodiment

The embodiment relates to a touch panel using the pressure sensor of the embodiments described above.

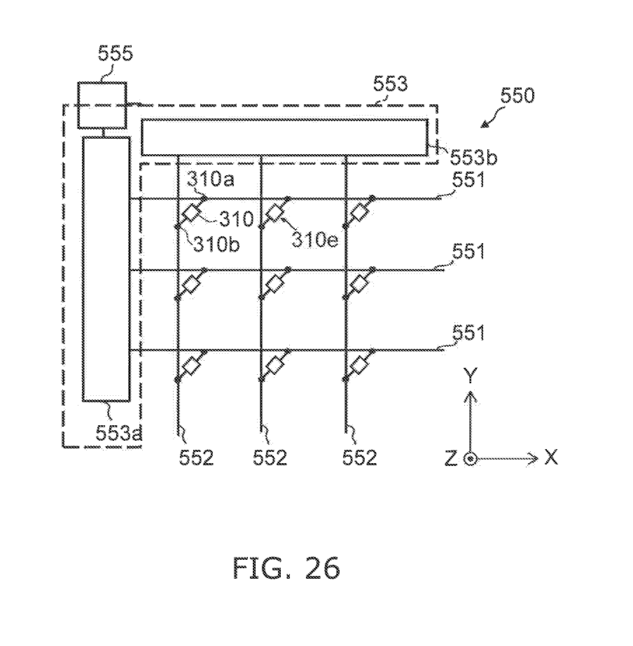

FIG. 26 is a schematic plan view illustrating a touch panel according to a seventh embodiment.

In the embodiment, the pressure sensor 310 may be used in a touch panel 550. The pressure sensor 310 includes any of the pressure sensors described in regard to the embodiments described above or a pressure sensor according to a modification of these pressure sensors. In the touch panel 550, the pressure sensor 310 is provided in the interior of the display and/or outside the display.

For example, the touch panel 550 includes plural first interconnects 551, plural second interconnects 552, the plural pressure sensors 310, and a controller 553.

In the example, the plural first interconnects 551 are arranged along the Y-axis direction. Each of the plural first interconnects 551 extends along the X-axis direction. The plural second interconnects 552 are arranged along the X-axis direction. Each of the plural second interconnects 552 extends along the Y-axis direction.

The plural pressure sensors 310 are provided respectively at intersection portions between the plural first interconnects 551 and the plural second interconnects 552. One pressure sensor 310 is used as one sensing component 310e for sensing. Herein, the intersection portions include positions where the first interconnects 551 and the second interconnects 552 intersect with each other and peripheral regions thereof.

One end 310a of each of the plural pressure sensors 310 is connected to each of the plural first interconnects 551, The other end 310b of each of the plural pressure sensors 310 is connected to each of the plural second interconnects 552.

The controller 553 is connected to the plural first interconnects 551 and the plural second interconnects 552.

For example, the controller 553 includes a first interconnect circuit 553a that is connected to the plural first interconnects 551, a second interconnect circuit 553b that is connected to the plural second interconnects 552, and a control circuit 555 that is connected to the first interconnect circuit 553a and the second interconnect circuit 553b.

The pressure sensor 310 can perform highly-sensitive pressure sensing with a small size. Thus, it is possible to realize a high definition touch panel.

Other than the applications described above, the pressure sensors according to the embodiments described above are applicable to various pressure sensor devices such as an atmospheric pressure sensor, an air pressure sensor of a tire.

According to the embodiments, it is possible to provide a pressure sensor of high sensitivity, a microphone, a blood pressure sensor and a touch panel, a pressure sensor manufacturing method, and a pressure sensor manufacturing apparatus.

Hereinabove, the embodiments of the invention are described with reference to the specific examples. However, the invention is not limited to the specific examples. For example, specific configurations of the respective components such as the film part, the sensing element, the first magnetic layer, the second magnetic layer and the intermediate layer included in the pressure sensor, the microphone, the blood pressure sensor and the touch panel are included in the scope of the invention as long as the specific configurations can be appropriately selected by those skilled in the art from known techniques to realize the invention in the same way and to achieve the same results.

Further, combinations of two or more components of the respective specific examples in a technically allowable range are also included in the scope of the invention in a range without departing from the spirit of the invention.

In addition, all pressure sensors, microphones, blood pressure sensors and touch panels obtainable by an appropriate design modification by those skilled in the art based on the pressure sensors, the microphones, the blood pressure sensors and the touch panels described above as the embodiments of the invention also are included in the scope of the invention in a range without departing from the spirit of the invention.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Hereinabove, the embodiments of the invention are described. The embodiments of the invention may be embodied in the following embodiments.

### Embodiment 1

A microphone comprising a pressure sensor,

the pressure sensor including:

a support unit;

a substrate supported by the support unit, the substrate being deformable; and

a plurality of sensing elements provided on a part of the substrate,

the sensing element including
a first magnetic layer in which magnetization changes according to deformation of the substrate,
a second magnetic layer in which magnetization is fixed, and
an intermediate layer provided between the first magnetic layer and the second magnetic layer, and

a direction of the magnetization of the second magnetic layer of a first sensing element among the plurality of sensing elements being different from a direction of the magnetization of the second magnetic layer of a second sensing element among the plurality of sensing elements.

### Embodiment 2

A blood pressure sensor comprising a pressure sensor,

the pressure sensor including:

a support unit;

a substrate supported by the support unit, the substrate being deformable; and

a plurality of sensing elements provided on a part of the substrate,

the sensing element including
a first magnetic layer in which magnetization changes according to deformation of the substrate,
a second magnetic layer in which magnetization is fixed, and
an intermediate layer provided between the first magnetic layer and the second magnetic layer, and

a direction of the magnetization of the second magnetic layer of a first sensing element among the plurality of sensing elements being different from a direction of the magnetization of the second magnetic layer of a second sensing element among the plurality of sensing elements.

### Embodiment 3

A touch panel comprising a pressure sensor,

the pressure sensor including:

a support unit;

a substrate supported by the support unit, the substrate being deformable; and

a plurality of sensing elements provided on a part of the substrate,

the sensing element including
a first magnetic layer in which magnetization changes according to deformation of the substrate,
a second magnetic layer in which magnetization is fixed, and
an intermediate layer provided between the first magnetic layer and the second magnetic layer, and

a direction of the magnetization of the second magnetic layer of a first sensing element among the plurality of sensing elements being different from a direction of the magnetization of the second magnetic layer of a second sensing element among the plurality of sensing elements.

### Embodiment 4

An apparatus for manufacturing a pressure sensor, comprising:

a first jig configured to fix a substrate on which a plurality of sensing elements is provided, the substrate being deformable, in which each sensing element includes a first magnetic layer in which magnetization changes according to deformation of the substrate, a second magnetic layer, and an intermediate layer provided between the first magnetic layer and the second magnetic layer;

a second jig provided above the first jig and configured to form a first space between the substrate and the second jig;

a third jig provided under the first jig and configured to form a second space between the substrate and the third jig; and

a pressure difference generator configured to generate a pressure difference between the first space and the second space and deform the substrate due to an external pressure based on the pressure difference.

What is claimed is:

1. A pressure sensor comprising:
a support unit;
a substrate supported by the support unit, the substrate being deformable; and
a plurality of sensing elements provided on a part of the substrate,
the sensing element including
a first magnetic layer in which magnetization changes according to deformation of the substrate,
a second magnetic layer in which magnetization is fixed, and
an intermediate layer provided between the first magnetic layer and the second magnetic layer, and
a direction of the magnetization of the second magnetic layer of a first sensing element among the plurality of sensing elements being different from a direction of the magnetization of the second magnetic layer of a second sensing element among the plurality of sensing elements.

2. The sensor according to claim 1, wherein
the support unit has a hollow part provided under the substrate, and
the plurality of sensing elements are disposed along an edge portion of the substrate.

3. The sensor according to claim 2, wherein
a difference between an angle formed by a straight line connecting a centroid of the first sensing element and the edge portion in the shortest distance and the magnetization of the second magnetic layer of the first sensing element and an angle formed by a straight line connecting a centroid of the second sensing element and the edge portion in the shortest distance and the magnetization of the second magnetic layer of the second sensing element is within 5°.

4. The sensor according to claim 2, wherein
a difference between an angle formed by a straight line connecting a centroid of the first sensing element and the centroid of the substrate and the magnetization of the second magnetic layer of the first sensing element and an angle formed by a straight line connecting a centroid of the second sensing element and the centroid of the substrate and the magnetization of the second magnetic layer of the second sensing element is within 5°.

5. The sensor according to claim 1, wherein
a difference between an angle formed by the magnetization of the first magnetic layer of the first sensing element and the magnetization of the second magnetic layer of the first sensing element and an angle formed by the magnetization of the first magnetic layer of the second sensing element and the magnetization of the second magnetic layer of the second sensing element is within 5°.

6. The sensor according to claim 1, wherein
a surface of the sensing element in a direction perpendicular to a stacked direction from the second magnetic layer to the first magnetic layer has shape anisotropy in which a length of a first axis is longer than a length of a second axis crossing the first axis.

7. The sensor according to claim 6, wherein
a difference between an angle formed by a straight line connecting a centroid of the first sensing element and the edge portion in the shortest distance and the first axis of the first sensing element and an angle formed by a straight line connecting a centroid of the second sensing element and the edge portion in the shortest distance and the first axis of the second sensing element is within 5°.

8. The sensor according to claim 6, wherein
a difference between an angle formed by a straight line connecting a centroid of the first sensing element and a centroid of the substrate and the first axis of the first sensing element and an angle formed by a straight line connecting a centroid of the second sensing element and a centroid of the substrate and the first axis of the second sensing element is within 5°.

9. The sensor according to claim 6, wherein
when an external force is not applied to the pressure sensor, the magnetization of the first magnetic layer is directed in a direction parallel to the first axis having the shape anisotropy.

10. The sensor according to claim 6, wherein
a difference between an angle formed by the magnetization of the second magnetic layer of the first sensing element and the first axis of the first sensing element and an angle formed by the magnetization of the second magnetic layer of the second sensing element and the first axis of the second sensing element is within 5°.

11. The sensor according to claim 1, wherein
a surface of the sensing element in a direction perpendicular to a stacked direction from the second magnetic layer to the first magnetic layer has shape isotropy in which a length of a first axis is equal to a length of a second axis perpendicular to the first axis.

12. The sensor according to claim 11, wherein
when elements among the sensing elements having the shape isotropy have sides, a difference between an angle formed by a straight line connecting a centroid of the first sensing element and the edge portion in the shortest distance and one side of the first sensing element and an angle formed by a straight line connecting a centroid of the second sensing element and the edge portion in the shortest distance and one side of the second sensing element is within 5°.

13. The sensor according to claim 11, wherein
when the elements among the sensing elements having the shape isotropy have the sides, a difference between an angle formed by a straight line connecting a centroid of the first sensing element and a centroid of the substrate and one side of the first sensing element and an angle formed by a straight line connecting a centroid of the second sensing element and the centroid of the substrate and one side of the second sensing element is within 5°.

14. The sensor according to claim 1, wherein
at least two among the plurality of sensing elements are electrically connected to each other in series.

15. The sensor according to claim 1, wherein
at least two among the plurality of sensing elements are electrically connected to each other in parallel.

16. A method for manufacturing a pressure sensor comprising:
forming a deformable substrate;
forming a plurality of sensing elements on the substrate, which includes forming, on the substrate, a first magnetic layer in which magnetization changes according to deformation of the substrate, forming a second magnetic layer, and forming an intermediate layer between the first magnetic layer and the second magnetic layer; and
performing heat treatment of the sensing elements in a state where the substrate is deformed due to an external pressure.

17. The method according to claim 16, wherein
magnetization of the second magnetic layer is fixed by the heat treatment based on a direction of stress caused in the sensing elements by the external pressure.

18. The method according to claim 16, wherein
the heat treatment for fixing the magnetization of the second magnetic layer is performed at a temperature between 250° C. and 400° C.

19. The method according to claim 16, wherein
the external pressure is generated by causing a pressure difference to occur between a space above the substrate and a space under the substrate.

20. The method according to claim 16, wherein
a size of the external pressure applied to spaces above and under the substrate is less than or equal to 30 kilopascals.
